(19) United States
(12) Patent Application Publication
(10) Pub. No.: US 2023/0016637 A1
(43) Pub. Date: Jan. 19, 2023

(54) Apparatus and Method for End-to-End Adversarial Blind Bandwidth Extension with one or more Convolutional and/or Recurrent Networks

(71) Applicants: Fraunhofer-Gesellschaft zur Foerderung der angewandten Forschung e.V., Munich (DE); Friedrich-Alexander-Universitaet Erlangen-Nuernberg, Erlangen (DE)

(72) Inventors: Konstantin SCHMIDT, Nuernberg (DE); Ahmed Mustafa Mahmoud AHMED, Erlangen (DE); Guillaume FUCHS, Erlangen (DE); Bernd EDLER, Fuerth (DE)

(21) Appl. No.: 17/369,113

(22) Filed: Jul. 7, 2021

(51) Int. Cl. G06N 3/08; G06N 3/04

(52) U.S. Cl. CPC G06N 3/088; G06N 3/0454

(57) ABSTRACT

An apparatus for processing a narrowband speech input signal by conducting bandwidth extension of the narrowband speech input signal to obtain a wideband speech output signal according to an embodiment is provided. The apparatus includes a signal envelope extrapolator including a first neural network, wherein the first neural network is configured to receive as input values of the first neural network a plurality of samples of a signal envelope of the narrowband speech input signal, and configured to determine as output values of the first neural network a plurality of extrapolated signal envelope samples. Moreover, the apparatus includes an excitation signal extrapolator configured to receive a plurality of samples of an excitation signal of the narrowband speech input signal, and configured to determine a plurality of extrapolated excitation signal samples. Furthermore, the apparatus includes a combiner configured to generate the wideband speech output signal such that the wideband speech output signal is bandwidth extended with respect to the narrowband speech input signal depending on the plurality of extrapolated signal envelope samples and depending on the plurality of extrapolated excitation signal samples.

### BACKGROUND OF THE INVENTION

The present invention relates to an apparatus and a method for end-to-end adversarial blind bandwidth extension with one or more convolutional and/or recurrent networks

Speech communication is a technology used by most people every day, creating a vast amount of data that needs to be transmitted over Voice over Internet Protocol (VoIP), cellular or public switched telephone networks. According to a 2017 OFCOM study an average of 156.75 monthly outbound mobile call minutes are made per subscription, see https://www.ofcom.org.uk/research-and-data/multi-sector-research/cmr/cmr-2018/interactive.

While the amount of transferred data should be kept low, the quality of speech is desired to be high. In order to reach this goal, speech compression technologies have evolved over the past decades from compressing bandlimited speech with simple pulse code modulation [1] to coding schemes following speech production and human perception models able to code fullband speech [2], [3]. Albeit the existence of such standardised speech codecs, their adoption in cellular or public switched telephone networks takes years if not decades. For this reason AMR-NB [4] remains the most frequently used codec for mobile speech communication which merely encodes frequencies from 200 Hz to 3400 Hz (usually named narrowband, NB). However, transmitting band-limited speech not only harms the acoustic quality but also the intelligibility [5], [6], [7]. Blind bandwidth extension (BBWE)—also known as artificial bandwidth expansion or audio super resolution—artificially regenerates missing frequency components without transmitting additional information from the encoder. A BBWE can be added to the decoder toolchain without any adaption of the transmission network and thus can serve as an intermediate solution to improve the perceived audio quality and intelligibility until better codecs will be deployed in the network [5], [6], [8]. For the sake of transmission bandwidth saving or quality improvement, robust BBWE can still be a viable solution for modern speech transmission. In addition and for other types of applications such as audio restoration, where band-limited speech is stored or archived, BBWE is the only possible solution to expand the audio bandwidth.

Despite the fact that BBWE has a long tradition in speech and audio signal processing community, [9], [10] it is only recently that solutions based on deep neural networks (DNN) has been considered if being developed by researchers with a background in artificial intelligence (AI) or image processing, rather than in speech signal processing. Such DNN-based systems are commonly called speech super resolution (SSR). In image processing, the task of estimating a high-resolution image from one or more low-resolution observations is referred as super-resolution and has received substantial attention within the computer vision community. Recently, Deep Convolutional Neural Networks have achieved better results than traditional methods [11], while super-resolution generative adversarial networks are considered as state-of-the-art [12].

A good BBWE not only increases the perceived quality of speech but can also improve word error rates of automated speech recognition systems [13].

Generative Adversarial Networks (GAN) can restitute better the finer structure for a more realistic reproduction. However, some of these systems cannot be directly applied to speech communication scenarios. Besides the fact that the underlying signal is of different nature (e.g. of different dimensionality), there are more aspects to be considered in the design of a BBWE: first of all, the algorithmic delay—that is the time the decoded speech lags behind the original speech—is not allowed to be too large. Furthermore, the computational complexity and memory consumption has to be able to satisfy requirements for real-time processing on embedded systems, such as on mobile phones.

Recurrent Neural Networks are well suited for analysing or predicting time-series, like speech. Indeed, speech can be considered as wide-sense stationary or quasi-periodic on durations of about 20 to 25 ms, and its time correlation can be exploited in RNNs with relatively small models. On the other hand, CNNs are performant in pattern recognition and upscaling tasks, as in image super-resolution. They also have the advantage that processing can be highly parallelised. Therefore, for speech processing, and particularly for BBWE, both architectures deserve to be considered.

As mentioned before, in the state of the art, the principle of BBWE was originally presented by Karl-Otto Schmidt in 1933 [9], using analog nonlinear devices to extend the bandwidth of transmitted speech. The idea of doing (non-blind) bandwidth extension on the excitation signal of speech codecs dates back to at least 1959 [10]. In the following years several so called parametric BWEs were presented that, motivated by the source-filter model of the human speech production, utilised the separation of the speech signal into excitation and spectral envelope. These systems apply statistical models to extrapolate the spectral envelope while generating the excitation signal by spectral folding [14], spectral translation [8] or by nonlinearities [15]. The statistical models for envelope extrapolation are simple codebook mappings [16], hidden Markov models [14], (shallow) neural networks [17], or recently DNNs [18].

Before using DNNs, the input to the statistical models were often hand-tailored features [14], [17], [19], [20]. With the introduction of DNNs, this approach can be simplified to directly using logarithmic short-time Fourier transform (SIFT) energies [18], [21], [22] or the time-domain speech signal [23], [24], [25]. The same is true for the output of the statistical models. Instead of modelling sub-band energies [8] or other envelope representations [21], DNNs are powerful enough to model spectral magnitudes per bin [15], if not the whole time-domain speech signal or a combination of time-domain and frequency domain [26]. However, if the spectral magnitude is modelled, the phase still needs to be reconstructed by spectral folding or translation [18], [21], [15], [27].

Regarding the training objective, designing an efficient DNN-based solution has the requirement of selecting the appropriate architecture, and primarily a careful choice of the learning loss function and network type. Typical loss functions are: mean-squared error [21], categorical cross entropy (CE) loss [28], adversarial loss [29], [30], [25] or a mixture of losses [31]. The loss function can also determine the data representation.

With respect to mean-squared error and cross entropy, mean-squared error (MSE) loss, in combination with logarithmic sub-band or bin energies allows for a psychoacoustically motivated loss [8]. Cross-entropy (XE)-derived loss functions predict sample bits (or sample magnitudes) as classes and therefore the signal to be modelled needs to be quantised with not too high resolution to be handled by DNNs. Predicting the 2¹⁶ classes of a speech signal quantised with 16 bits is still very costly to be handled by DNNs up to the present day. Fortunately, it is sufficient to quantise the speech signal content above 3.4 kHz with 8 bits without any noteworthy loss in quality [32]. Since the distribution of the data to be trained with cross entropy loss is desired to be Gaussian rather than e.g. the more Laplacian distribution of the speech signal [34], it is usually preshaped by a non-linear function. Surprisingly, the p-law function used in [35], [32], [23], [24], to make the speech data x more Gaussian is the very same as the first ever standardised digital speech codec [1]:

$$f ( x ) = sgn ( x ) \frac{ln ( 1 + ( x ) )}{ln ( 256 )} , - 1 < x < 1 \qquad ( 1 )$$

With respect to adversarial loss, the distribution of time-domain speech is very complex and hard to model, even with today's powerful networks. Generative models trained with MSE or CE loss to match this complex distribution, will only produce a smoothed approximation thereof. When applied to BBWE, this means that the resulting speech signal will lack crispness and energy [30].

Generative adversarial networks [36] can be seen as a kind of extended loss function. Here, two networks, a generator and a discriminator compete against each other. FIG. 2 illustrates a generative adversarial network. The generator tries to generate realistic data while the discriminator distinguishes between the generated data and the data from the training database. After successful training, the discriminator is not needed any longer, its mere purpose lies in providing a better loss for the generator. The reason why adversarial training is interesting for training generative models like BBWEs is due to their ability to model some modes of a distribution without smoothing or averaging over all modes.

Regarding the class of networks, it is noted that another important aspect in the design of a DNN is the choice of class of networks to be used. Of popular choice are fully connected layers [18], [21], convolutional neural networks (CNN) [11], [37] or recurrent neural networks (RNN), with their known sub-types called long short-term memory (LSTM) units [38], [39], [8] or gated recurrent units (GRU) [40], [39]. Fully connected layers are only used in systems that operate on frames [18], [21] while RNNs and CNNs allow for processing of time-domain data in a streaming way [23], [24].

With respect to autoregressive networks, it is noted that a remarkable contribution to field of generative DNN models was WaveNet® [35], a model first used for speech synthesis. In this work and their previously released PixelCNN [41], the authors introduced several innovations. WaveNet® models the speech distribution as a product of conditional probabilities and a compact feature representation h:

$$p ( x ) = {\prod }_{t = 1}^{T} p ( {x}_{t} \vert {x}_{1} , … , {x}_{t - 1} , h ) , \qquad ( 2 )$$

where xₜ is a speech sample at time t. Each audio sample is therefore conditioned on previous samples. This is implemented with causal convolutions. As a result, the network predicts samples that are fed back into the network. This is different to RNNs, in which the network architecture is autoregressive, whilst the training does not depend on generated samples. Furthermore, they use dilated convolution with gated activation units and conditioning:

z=tan h(K_{f,k}*x)⊙σ(K_{g,k}*x)) (3)

in which * denotes a convolution operator, ⊙ denotes an element-wise multiplication operator, σ( ) denotes a sigmoid function, k is the layer index, f and g denote filter and gate, respectively, and K is a learnable convolution filter kernel.

WaveNet® has also been adopted for BBWE. In [42], it is trained on clean speech, conditioned with bitstream parameters of coded NB speech. Here the network acts as a decoder, implicitly doing bandwidth extension. Following this, in [24] WaveNet® is conditioned with features calculated on NB signal. After successful training, only the features are fed to the network and the NB speech signal is neglected.

While WaveNet®-based models claim very high perceptual quality, they are hard to train and the computational complexity at evaluation time is very high. This gave rise to several optimisations and alternative models (e.g. [43]). One particular alternative is LPCNet, originally designed for either speech synthesis [32] or speech coding [44]. In LPCNet the convolutional layers of WaveNet® are replaced by recurrent layers.

### SUMMARY

An embodiment may have an apparatus for processing a narrowband speech input signal by conducting bandwidth extension of the narrowband speech input signal to acquire a wideband speech output signal, wherein the apparatus has: a signal envelope extrapolator having a first neural network, wherein the first neural network is configured to receive as input values of the first neural network a plurality of samples of a signal envelope of the narrowband speech input signal, and configured to determine as output values of the first neural network a plurality of extrapolated signal envelope samples; an excitation signal extrapolator configured to receive a plurality of samples of an excitation signal of the narrowband speech input signal, and configured to determine a plurality of extrapolated excitation signal samples; and a combiner configured to generate the wideband speech output signal such that the wideband speech output signal is bandwidth extended with respect to the narrowband speech input signal depending on the plurality of extrapolated signal envelope samples and depending on the plurality of extrapolated excitation signal samples.

Another embodiment may have a method for processing a narrowband speech input signal by conducting bandwidth extension of the narrowband speech input signal to acquire a wideband speech output signal, wherein the method has the steps of: receiving, as input values of a first neural network, a plurality of samples of a signal envelope of the narrowband speech input signal, and determining as output values of the first neural network a plurality of extrapolated signal envelope samples; receiving a plurality of samples of an excitation signal of the narrowband speech input signal, and determining a plurality of extrapolated excitation signal samples; and generating the wideband speech output signal such that the wideband speech output signal is bandwidth extended with respect to the narrowband speech input signal depending on the plurality of extrapolated signal envelope samples and depending on the plurality of extrapolated excitation signal samples.

Another embodiment may have a method for training a neural network, wherein the neural network receives as input values of the neural network are a first plurality of line spectral frequencies of a narrowband speech input signal; wherein the neural network determines as output values of the first neural network a second plurality of line spectral frequencies of the wideband speech output signal; wherein each of one or more of the second plurality of line spectral frequencies is associated with a frequency being greater than any frequency being associated with any of the first plurality of line spectral frequencies; wherein the second plurality of line spectral frequencies of the wideband speech output signal is transformed from a line spectral frequency domain to a linear predictive coding domain to acquire a second plurality of the linear predictive coding coefficients of the wideband speech output signal; wherein a finite impulse response filter is employed to transform the second plurality of the linear predictive coding coefficients of the wideband speech output signal from the linear predictive coding domain to a finite impulse response filter domain to acquire a plurality of finite-impulse-filter-transformed linear predictive coding coefficients; wherein the method includes training the first neural network depending on the plurality of finite-impulse-filter-transformed linear predictive coding coefficients.

Another embodiment may have a method for training a first and/or a second neural network, wherein the first neural network receives as input values of the first neural network a plurality of samples of a signal envelope of the narrowband speech input signal, and determines as output values of the first neural network a plurality of extrapolated signal envelope samples; and/or wherein the second neural network receives as input values of the second neural network the plurality of samples of the excitation signal of the narrowband speech input signal, and determines as output values of the second neural network the plurality of extrapolated excitation signal samples; wherein the first and/or the second neural network is trained using a discriminator neural network; wherein, when the first and/o the second neural network is trained, the first and/or the second neural network and the discriminator neural network operate as a generative adversarial network; wherein, during training of the first and/or the second neural network, the discriminator neural network receives, as input values of the discriminator neural network, the output values of the first and/or the second neural network or receives, as the input values of the discriminator network, derived values being derived from the output values of the first and/or the second neural network; wherein, on receiving the input values of the discriminator neural network, the discriminator neural network determines, as output of the discriminator neural network, a quality indication for the input values of the discriminator neural network; and wherein the first neural network and/or the second is trained depending on the quality indication.

Another embodiment may have a non-transitory digital storage medium having a computer program stored thereon to perform the methods according to the invention.

An apparatus for processing a narrowband speech input signal by conducting bandwidth extension of the narrowband speech input signal to obtain a wideband speech output signal according to an embodiment is provided. The apparatus comprises a signal envelope extrapolator comprising a first neural network, wherein the first neural network is configured to receive as input values of the first neural network a plurality of samples of a signal envelope of the narrowband speech input signal, and configured to determine as output values of the first neural network a plurality of extrapolated signal envelope samples. Moreover, the apparatus comprises an excitation signal extrapolator 130 configured to receive a plurality of samples of an excitation signal of the narrowband speech input signal, and configured to determine a plurality of extrapolated excitation signal samples. Furthermore, the apparatus comprises a combiner 140 configured to generate the wideband speech output signal such that the wideband speech output signal is bandwidth extended with respect to the narrowband speech input signal depending on the plurality of extrapolated signal envelope samples and depending on the plurality of extrapolated excitation signal samples.

Moreover, a method for processing a narrowband speech input signal by conducting bandwidth extension of the narrowband speech input signal to obtain a wideband speech output signal according to an embodiment is provided. The method comprises:
Receiving, as input values of a first neural network, a plurality of samples of a signal envelope of the narrowband speech input signal, and determining as output values of the first neural network a plurality of extrapolated signal envelope samples.
Receiving a plurality of samples of an excitation signal of the narrowband speech input signal, and determining a plurality of extrapolated excitation signal samples. And:
Generating the wideband speech output signal such that the wideband speech output signal is bandwidth extended with respect to the narrowband speech input signal depending on the plurality of extrapolated signal envelope samples and depending on the plurality of extrapolated excitation signal samples.

Furthermore, a method for training a neural network according to an embodiment is provided.
The neural network receives as input values of the neural network are a first plurality of line spectral frequencies of a narrowband speech input signal.
The neural network determines as output values of the first neural network a second plurality of line spectral frequencies of the wideband speech output signal; wherein each of one or more of the second plurality of line spectral frequencies is associated with a frequency being greater than any frequency being associated with any of the first plurality of line spectral frequencies.
The second plurality of line spectral frequencies of the wideband speech output signal is transformed from a line spectral frequency domain to a linear predictive coding domain to obtain a second plurality of the linear predictive coding coefficients of the wideband speech output signal.
A finite impulse response filter is employed to transform the second plurality of the linear predictive coding coefficients of the wideband speech output signal from the linear predictive coding domain to a finite impulse response filter domain to obtain a plurality of finite-impulse-filter-transformed linear predictive coding coefficients.
The method comprises training the first neural network depending on the plurality of finite-impulse-filter-transformed linear predictive coding coefficients.

In an embodiment, when the first neural network is trained, the plurality of finite-impulse-filter-transformed linear predictive coding coefficients or values derived from the plurality of finite-impulse-filter-transformed linear predictive coding coefficients may, e.g., be fed back into the neural network.

According to an embodiment, when the first neural network is trained, a plurality of samples of the wideband speech output signal may, e.g., be generated depending on the plurality of finite-impulse-filter-transformed linear predictive coding coefficients and depending on a plurality of extrapolated excitation signal samples, and the plurality of the wideband speech output signal or values derived from the plurality of samples of the wideband speech output signal may, e.g., be fed back into the neural network.

Moreover, a method for training a first and/or a second neural network according to an embodiment is provided.
The first neural network receives as input values of the first neural network a plurality of samples of a signal envelope of the narrowband speech input signal, and determines as output values of the first neural network a plurality of extrapolated signal envelope samples; and/or wherein the second neural network receives as input values of the second neural network the plurality of samples of the excitation signal of the narrowband speech input signal, and determines as output values of the second neural network the plurality of extrapolated excitation signal samples.
The first and/or the second neural network is trained using a discriminator neural network; wherein, when the first and/o the second neural network is trained, the first and/or the second neural network and the discriminator neural network operate as a generative adversarial network.
During training of the first and/or the second neural network, the discriminator neural network receives, as input values of the discriminator neural network, the output values of the first and/or the second neural network or receives, as the input values of the discriminator network, derived values being derived from the output values of the first and/or the second neural network.
On receiving the input values of the discriminator neural network, the discriminator neural network determines, as output of the discriminator neural network, a quality indication for the input values of the discriminator neural network; and wherein the first neural network and/or the second is trained depending on the quality indication.

According to an embodiment, the discriminator neural network may, e.g., be a first discriminator neural network. The first neural network may, e.g., be trained using the first discriminator neural network; wherein the first neural network is trained depending on the quality indication being a first quality indication. The second neural network may, e.g., be trained using a second discriminator neural network, wherein, during training of the second neural network, the second neural network and the second discriminator neural network may, e.g., operate as a second generative adversarial network. During training of the second neural network, the second discriminator neural network may, e.g., receive, as input values of the second discriminator neural network, the output values of the second neural network or may, e.g., receive, as the input values of the second discriminator network, derived values being derived from the output values of the second neural network. On receiving the input values of the second discriminator neural network, the second discriminator neural network determines, as output of the second discriminator neural network, a second quality indication for the input values of the second discriminator neural network; and wherein the second neural network is configured to be trained depending on the second quality indication.

Moreover, computer programs are provided, wherein each of the computer programs is configured to implement one of the above-described methods when being executed on a computer or signal processor.

As already outlined, blind bandwidth extension improves the perceived quality and intelligibility of telephone-quality speech by artificially regenerating missing frequency content that is not coded and transmitted by speech codecs. Embodiments provide novel approaches based on deep neural networks to solve this problem. These embodiments are based on convolutional or on recurrent architectures. All operate in time-domain. Motivated by the source-filter model of the human speech production, two of the provided systems decompose speech signals into spectral envelopes and excitation signals; each of them are bandwidth extended separately with a dedicated DNN. All systems are trained with a mixture of adversarial and perceptual loss. To avoid mode collapse and a more stable adversarial training, spectral normalization may, e.g., be employed in the discriminator.

Embodiments provide two BBWEs based on deep neural networks using adversarial learning targeting speech coding scenarios.

According to embodiments, two novel deep network structures for the purpose of blind bandwidth extension are provided, one based on convolutional kernels and the other one based on recurrent kernels.

Both networks may, e.g., be trained with a mixture of adversarial and spectral loss.

The two systems are BBWEs trained adversarially and “end-to-end”—meaning that the input is time-domain speech as well as the output.

In embodiments, hinge loss and spectral normalisation may, e.g., be applied to increase the performance of the GAN.

Embodiments provide new approaches for BBWE based on generative models used for bandwidth extension of speech signals.

For two of the presented systems, an established paradigm from the speech coding world, namely the decomposition of the speech signal into envelope and excitation signal known as the source-filter model, may, e.g., be applied to GAN models. As a result, the computational complexity may, e.g., be lowered, e.g., by a factor of about 3. This approach was tested and evaluated within the application of BBWE but is not limited to it. Systems according to embodiments improve the speech recognition error rate of NB speech significantly.

Some of the embodiments provide a generative model for generating enhanced speech from coded or bandlimited or corrupted speech.

According to embodiments, target speech for training may, e.g., be decomposed into envelope and excitation. The envelope may, e.g., be LPC coefficients. The excitation may, e.g., be an LPC residual.

In some of the embodiments, the envelope and the excitation may, e.g., be trained separately. Each of the envelope and the excitation may, e.g., be trained with a mixture of adversarial loss (known from generative adversarial networks (GAN)) and L¹-loss. For the excitation signal training there is also a feature loss added.

According to embodiments, the envelope may, e.g., be trained with coded and/or bandlimited and/or corrupted envelope representation as input and original envelope as target. Possible envelope representation may, e.g., be the LPC coefficients.

In embodiments, the input for training the excitation signal may, e.g., be coded and/or bandlimited and/or corrupted time-domain speech and/or a compressed feature representation. The target may, e.g., be original clean speech.

According to embodiments, for training the excitation signal, the loss may, e.g., be propagated through the envelope. This may, for example, be done by regarding the envelope as a DNN layer that propagates the loss. In case the envelope is represented by an LPC filter, this filter may, e.g., be a pure IIR filter. In this case the loss may, e.g., propagate slow or not at all (also known as the vanishing gradient problem). In an embodiment, an IIR filter may, e.g., be approximated by an FIR filter by truncating the impulse response. As a result the envelope may, e.g., be implemented as a convolutional layer (CNN-layer) in the network.

Some embodiments are based on the decomposition of the speech signal into excitation signal and an envelope—similar to speech codecs [2], [4]. This is accomplished with linear predictive coding (LPC). The recurrent layers merely model the excitation signal, which is easier to predict. In some embodiments, LPCNet is also adopted for BBWE [33].

### BRIEF DESCRIPTION OF THE DRAWINGS

Embodiments of the present invention will be detailed subsequently referring to the appended drawings, in which:

FIG. 1 illustrates an apparatus for processing a narrowband speech input signal by conducting bandwidth extension of the narrowband speech input signal to obtain a wideband speech output signal according to an embodiment.

FIG. 2 illustrates a generative adversarial network.

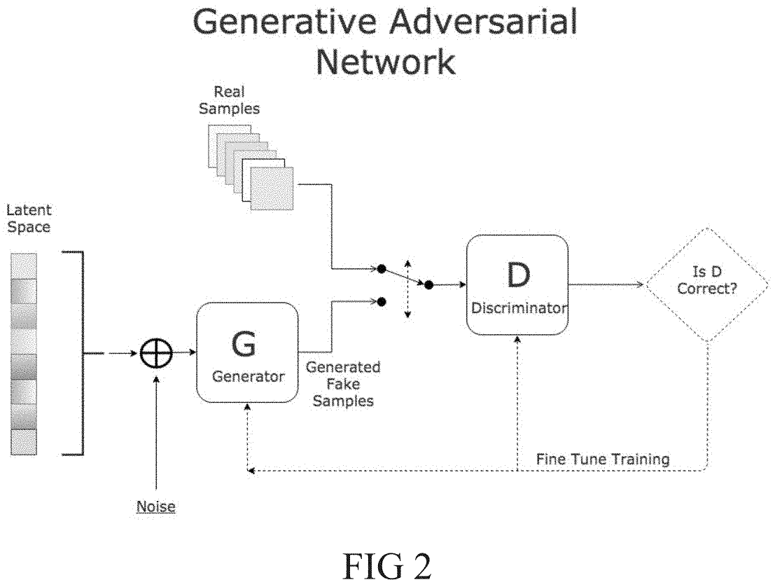

FIG. 3 illustrates a single layer of the CNN-GAN with softmax-gated activations.

FIG. 4 illustrates a proposed system based on the decomposition of the speech signal into excitation signal and LPC envelope.

FIG. 5 illustrates transfer functions of an IIR LPC filter of order 12 and FIR filters resulting from a truncated impulse response.

FIG. 6 illustrates a structure of the DNN extrapolating the excitation signal.

FIG. 7 illustrates one of the matrices from a GRU after sparsification.

FIG. 8 illustrates the GAN discriminator network consisting of six convolutional layers with each layer having kernels of 32 samples operating at strides of 2.

FIG. 9 illustrates a Perceptual Objective Listening Quality Analysis of different BBWEs with 95% confidence intervals.

FIG. 10 illustrates the Fréchet Deep Speech Distance (FDSD) of different BBWEs.

FIG. 11 illustrates a word error rate and character error rate of different BBWEs.

FIG. 12 illustrates a Short-Time Objective Intelligibility measure (STOI) for the presented systems.

FIG. 13 illustrates results from listening test evaluating different BBWEs as boxplot with 95% confidence intervals per item.

FIG. 14 illustrates results from listening test evaluating different BBWEs as bar plot with 95% confidence intervals averaged over all items.

FIG. 15 illustrates results from listening test evaluating different BBWEs as warm plot showing the ratings from each user.

FIG. 16 illustrates normalised objective and subjective measures.

### DETAILED DESCRIPTION OF THE INVENTION

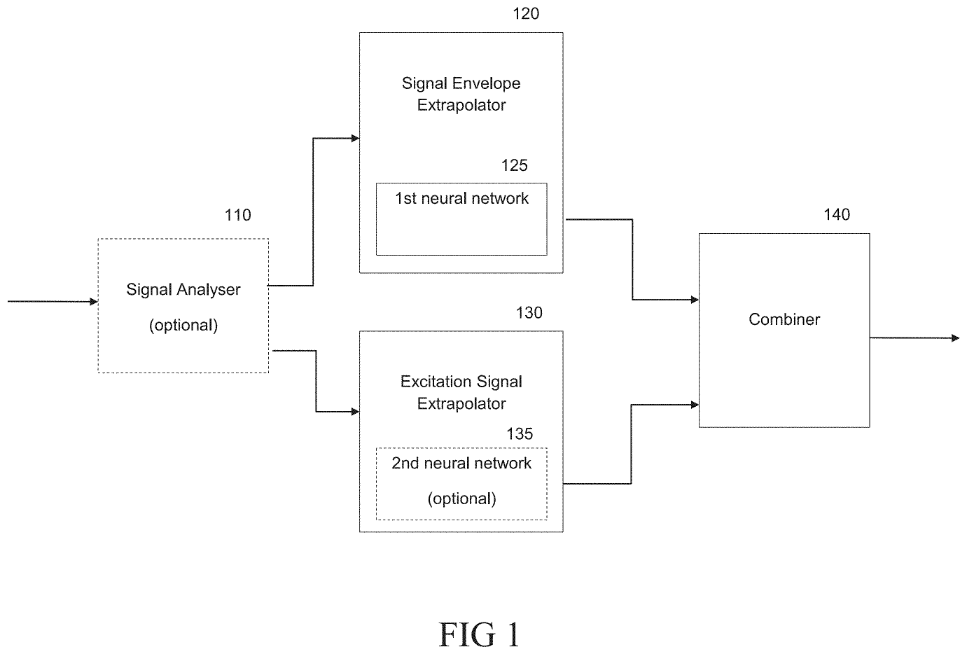

FIG. 1 illustrates an apparatus for processing a narrowband speech input signal by conducting bandwidth extension of the narrowband speech input signal to obtain a wideband speech output signal according to an embodiment.

The apparatus comprises a signal envelope extrapolator 120 comprising a first neural network 125, wherein the first neural network 125 is configured to receive as input values of the first neural network 125 a plurality of samples of a signal envelope of the narrowband speech input signal, and configured to determine as output values of the first neural network 125 a plurality of extrapolated signal envelope samples.

Moreover, the apparatus comprises an excitation signal extrapolator 130 configured to receive a plurality of samples of an excitation signal of the narrowband speech input signal, and configured to determine a plurality of extrapolated excitation signal samples.

Furthermore, the apparatus comprises a combiner 140 configured to generate the wideband speech output signal such that the wideband speech output signal is bandwidth extended with respect to the narrowband speech input signal depending on the plurality of extrapolated signal envelope samples and depending on the plurality of extrapolated excitation signal samples.

According to an embodiment, the input values of the first neural network 125 are a first plurality of line spectral frequencies of the narrowband speech input signal, and wherein the first neural network 125 may, e.g., be configured to determine as the output values of the first neural network 125 a second plurality of line spectral frequencies of the wideband speech output signal; wherein each of one or more of the second plurality of line spectral frequencies may, e.g., be associated with a frequency being greater than any frequency being associated with any of the first plurality of line spectral frequencies.

In an embodiment, when the first neural network 125 is trained, the signal envelope extrapolator 120 may, e.g., be configured to transform a plurality of wideband linear predictive coding coefficients, being derived from an original speech signal, into finite impulse response filter coefficients by calculating an impulse response and by truncating the impulse response.

For example, the wideband LPC filter coefficients, which may, e.g., be IIR filter coefficients, are transformed to Finite impulse response filter coefficients by calculating the impulse response and truncating it. Since this is done during training, the wideband LPC filter coefficients used to convert to Finite impulse response filter coefficients may, e.g., be derived from the original wideband speech.

According to an embodiment, wherein, when the first neural network 125 is trained, the signal envelope extrapolator 120 may, e.g., be configured to feed back an error or a gradient of the error between the wideband speech output signal and the original wideband speech signal.

As outlined above, in an embodiment, the gradient of the error is back-propagated The error, here, is the difference between the generated wideband speech and the true wideband speech.

In general, from narrowband speech, the excitation and from that the envelope is generated. Finally the wideband speech is derived.

During application, the output of the excitation signal extrapolator 130 may, e.g., be fed into the signal envelope extrapolator 120.

In an embodiment, during training with back propagation, the gradient of the error is first passed backwards to the signal envelope extrapolator 120 and then to the excitation signal extrapolator 130.

If the signal envelope would be an IIR structure or filter, it would not be possible to pass the gradient. For this reason, the signal envelope is converted to a Finite impulse response filer.

According to an embodiment, the first neural network 125 may, e.g., be trained using a first discriminator neural network; wherein, when the first neural network 125 may, e.g., be trained, the first neural network 125 and the first discriminator neural network are arranged to operate as a generative adversarial network. During training of the first neural network 125, the first discriminator neural network may, e.g., be arranged to receive, as input values of the first discriminator neural network, the output values of the first neural network 125 or may, e.g., be arranged to receive, as the input values of the first discriminator network, derived values being derived from the output values of the first neural network 125. On receiving the input values of the first discriminator neural network, the first discriminator neural network may, e.g., be configured to determine, as output of the first discriminator neural network, a first quality indication for the input values of the first discriminator neural network; and wherein the first neural network 125 may, e.g., be configured to be trained depending on the first quality indication.

In an embodiment, on receiving the input values of the first discriminator neural network, the first discriminator neural network may, e.g., be configured to determine the quality indication such that the quality indication indicates a probability for that the input values of the first discriminator neural network relate to a recorded speech signal instead of an artificially generated speech signal, or indicates an estimation whether the output values of the first discriminator neural network relate to a recorded signal or to an artificially generated signal.

According to an embodiment, the first neural network 125 or the second neural network 135 may, e.g., have been trained using a loss function depending on the quality indication determined by the first discriminator neural network.

In an embodiment, the loss function may, e.g., depend on a Hinge loss or depends on a Wasserstein distance or may, e.g., depend on an entropy-based loss.

According to an embodiment, the loss function depends on a Hinge loss L_{hinge} being defined as:

L_{hinge}=max(0,1−D( ))

wherein D( )) indicates the output of the first discriminator neural network.

In an embodiment, the loss function may, e.g., depend on an (additional) L^{P}-loss. According to an embodiment, the loss function may, e.g., be defined according to:

L=(1−λ)L_{hinge}+λ(L¹+Lₘₑₜ).

In an embodiment, wherein the first discriminator neural network may, e.g., have been trained using recorded speech.

According to an embodiment, the excitation signal extrapolator 130 may, e.g., comprise a second neural network 135, wherein the second neural network 135 may, e.g., be configured to receive as input values of the second neural network 135 the plurality of samples of the excitation signal of the narrowband speech input signal, and/or the narrowband speech input signal, and/or a shaped version of the narrowband speech input signal. The second neural network 135 may, e.g., be configured to determine as output values of the second neural network 135 the plurality of extrapolated excitation signal samples.

In an embodiment, the input values of the second neural network 135 may, e.g., be a first plurality of time-domain signal samples of the excitation signal of the narrowband speech input signal, and/or may, e.g., be the narrowband speech input signal, and/or may, e.g., be a shaped version of the narrowband speech input signal. The second neural network 135 may, e.g., be configured to determine the output values of the second neural network 135 such that the plurality of extrapolated excitation signal samples are a second plurality of time-domain signal samples of an extended time-domain excitation signal being bandwidth-extended with respect to the excitation signal of the narrowband speech input signal.

According to an embodiment, the second neural network 135 may, e.g., be to be trained using a second discriminator neural network, wherein, during training of the second neural network 135, the second neural network 135 and the second discriminator neural network are arranged to operate as a second generative adversarial network. During training of the second neural network 135 the second discriminator neural network may, e.g., be arranged to receive, as input values of the second discriminator neural network, the output values of the second neural network 135 or may, e.g., be arranged to receive, as the input values of the second discriminator network, derived values being derived from the output values of the second neural network 135. And/or the second discriminator neural network may, e.g., be arranged to receive, as input values of the second discriminator neural network an output of the combiner 140.

On receiving the input values of the second discriminator neural network, the second discriminator neural network may, e.g., be configured to determine, as output of the second discriminator neural network, a second quality indication for the input values of the second discriminator neural network; and wherein the second neural network 135 may, e.g., be configured to be trained depending on the second quality indication.

In an embodiment, the apparatus may, e.g., comprise a signal analyser 110 configured to generate the plurality of samples of the signal envelope of the narrowband speech input signal and the plurality of samples of the excitation signal of the narrowband speech input signal from the narrowband speech input signal.

According to an embodiment, the first neural network 125 may, e.g., comprise one or more convolutional neural networks.

In an embodiment, the first neural network 125 may, e.g., comprise one or more deep neural networks.

Particular embodiments will now be described.

In the following three BBWEs based on DNNs according to embodiments are described: Two based on convolutional architectures, the other one based on a mixture of convolutional and recurrent architectures. All may, e.g., be trained adversarial with the same discriminator, the same perceptual loss and the same optimisation algorithm. The architecture of the first BBWE is inspired by WaveNet®, the other architectures are inspired by LPCNet. First, all generator networks are presented and since all systems share the same discriminator, it will be described below.

At first a convolutional BBWE according to embodiments is described.

The first architectural proposal for this task is a stack of convolutional neural networks (CNNs) as this is currently the standard building block of GANs. Using CNNs enables fast processing especially on GPUs.

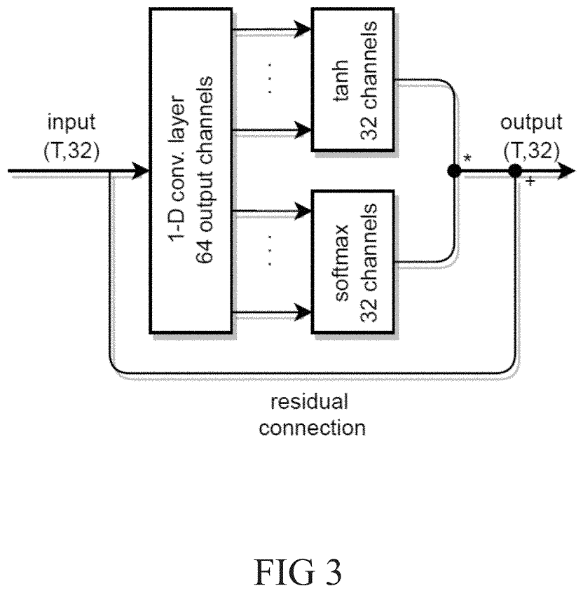

We adopted a WaveNet®-like structure for the convolutional generator model. Specifically, it is a stack of 20 layers where each layer uses causal convolutions with a kernel size of 33 and softmax-gated activations [45] for all layers. Biases have been omitted. One of these layers is displayed in FIG. 3.

FIG. 3 illustrates a single layer of the CNN-GAN with softmax-gated activations. The CNN layer has 1-dimensional kernels with 32 input channels and 64 output channels. Half of the output channels are fed into tan h-activations and the other half is fed into softmax activation. The residual connection avoids vanishing gradients and maintains a stable and effective training.

As outlined, each the CNN layers has 32 input channels and 64 output channels. Half of the output channels are fed into tan h-activations and the other half is fed into softmax activation. Both activations are multiplied over the channel dimension in order to form the 32 channel output of each layer. This type of activation is more robust against reconstruction artefacts than both ReLU and sigmoid-gated activation.

An additional input layer maps the one-dimensional input signal to a 32-dimensional signal and an additional output layer maps the 32-dimensional signal back to a one-dimensional output signal.

The weights of the convolutional kernels are normalized using weight normalisation [46] to enable stable training behaviour. We also apply batch normalisation to the output features from the CNN layers to speed up the training process.

Accordingly, a complete convolutional layer consists of causal convolution followed by batch normalisation and finally the softmax-gated activation to obtain the final output. There is also a residual connection or shortcut from the input to the output in order to avoid vanishing gradients and maintain stable and effective training [47].

In this convolutional BBWE, the model runs on raw speech waveforms in time domain. The input signal is firstly resampled from NB to WB using a simple Sinc interpolation, then it is fed to the generator model. The generator takes care of extending the original bandwidth of this upsampled signal reliably to get a complete WB structure with clearly higher perceptual quality.

This system is called CNN-GAN.

Now, LPC-GAN according to embodiments are described.

In particular, two systems according to embodiments are provided that differ from the convolutional one in two aspects: First the architecture of the DNNs differs, second, the speech signal is decomposed into an excitation signal and an envelope. This is inspired by the BBWE based on LPCNet [33], but some embodiments comprise adaptations. The motivation for decomposing the signal into excitation and envelope is the same as for the BBWE based on LPCnet [33], namely the reduction of computational complexity of the whole systems.

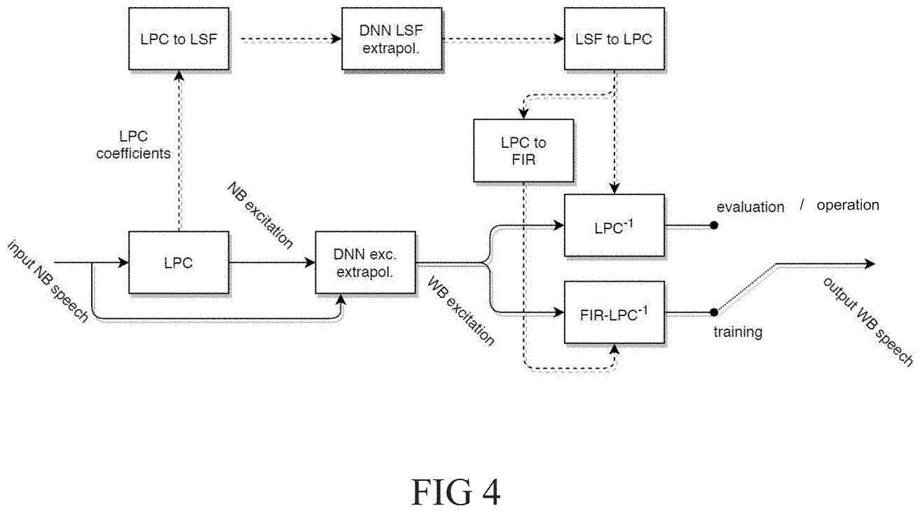

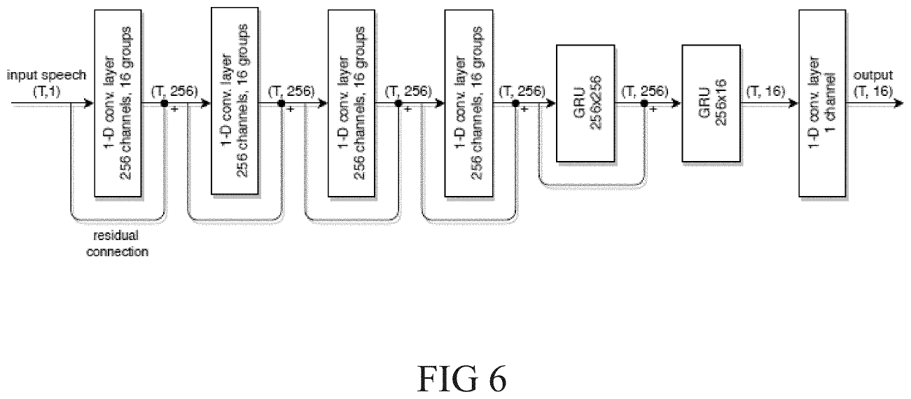

FIG. 4 shows a block diagram of the system and FIG. 6 shows one of the DNNs bandwidth extending the excitation signal in detail. In particular, FIG. 4 illustrates a proposed system based on the decomposition of the speech signal into excitation signal and LPC envelope. All paths with solid lines operate in samples, all paths with dashed lines operate on frames of 15 ms.

In FIG. 4, the input NB speech signal is separated into LPCs representing the spectral envelope and an excitation signal (a.k.a residual). The excitation signal and the input signal are fed to the first DNN for extrapolation to a WB excitation signal. This path operates on samples, shown here as solid lines. The LPCs are extrapolated to a WB envelope with a second DNN in the upper path. This path operates on frames of 15 ms, shown here as dashed lines. Since LPC coefficients are IIR filter coefficients and manipulations like extrapolation could result in an unstable filter, they are extrapolated in the LSF domain [48]. LSFs are a bijective transformation of LPCs with several advantages: First, they are less sensitive to noise disturbances and an ordered set of LSFs with a minimum distance between the coefficients will guarantee a stable LPC filter. Second, the spectral envelope at a particular frequency depends only on one of the LSFs so an erroneous extrapolation of a single LSF coefficient mainly affects the spectral envelope at a limited frequency range. These properties make them suitable for being extrapolated to a set representing a WB envelope. The extrapolated LSF coefficients are transformed back to the LPC domain for shaping the extrapolated excitation signal, which forms the output signal. This is achieved in different ways for training and evaluation.

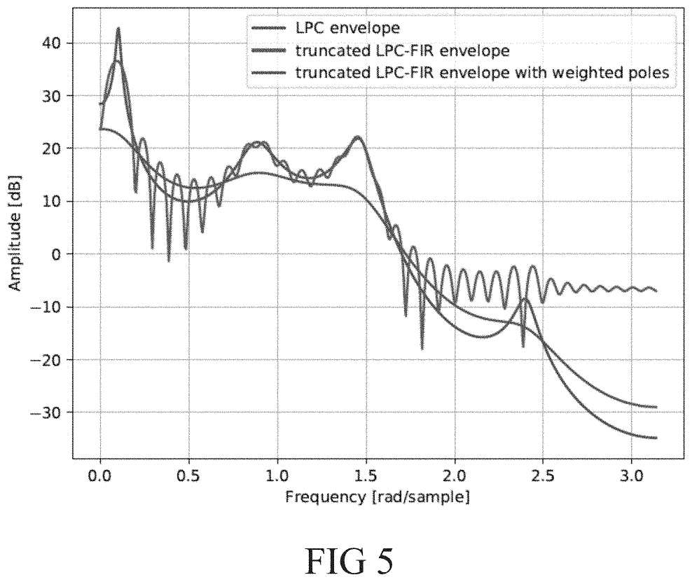

The extrapolated excitation signal, shaped by the LPC envelope, forms the output WB signal. While training the DNN that extrapolates the excitation signal, the gradient needs to be propagated through the LPC filter, which can be achieved when the LPC filtering is performed by an additional DNN layer. Since the LPC filter is a pure IIR filter, this DNN layer should be a layer with recurrent units. Unfortunately, backpropagating gradients through a recurrent layer will cause the gradient to vanish (a.k.a. vanishing gradient problem [38]) and result in poor training. As a solution to this problem, the IIR filter coefficients are transformed into FIR filter coefficients by calculating the truncated impulse response from the IIR filter. It is known from signal processing that any IIR filter can be approximated by an FIR filter by truncating the infinite impulse response [34]. Then, the LPC shaping can be implemented with a convolutional layer. FIG. 5 shows the effect of truncating it to 64 samples.

FIG. 5 illustrates transfer functions of an IIR LPC filter of order 12 and FIR filters resulting from a truncated impulse response.

While the IIR LPC envelope is smooth, the truncated FIR envelope has lots of ripples and does not follow well the IIR envelope in high frequencies. For this reason the LPC coefficients are multiplied with an exponential function before calculating the truncated impulse response:

\hat{α}ᵢ=αᵢ·0.8ⁱ for i=0, . . . ,12 (4)

Here αᵢ are the IIR LPC coefficients calculated by the Levinson-recursion. The resulting \hat{α}ᵢ coefficients have less pronounced poles and are suitable for calculating the FIR envelope as shown in FIG. 5. However, less pronounced poles result in less shaping and thus not being as efficient as pure IIR coefficients.

In FIG. 5, the impulse response was truncated to 64 samples. For the filter shown in green, the IIR LPC coefficients were processed with Eq. 4, for the filter shown in red no processing was used.

Initial experiments have shown that the FIR shaped signal contains artefacts, which could easily be identified by the discriminator. As a result, the adversarial loss was not balanced and the generator was training poor. This could be solved by calculating the adversarial loss on the real and generated unshaped excitation signal.

The LPC shaping by an FIR filter is done only during training time. During evaluation time, no gradient needs to be backpropagated, so the LPC coefficients are applied as an IIR filter.

Two different DNN are used for extrapolating the excitation signal, the first is based on a mixture of convolutional and recurrent layers, the second on convolutional architectures only. The first is shown in detail in FIG. 6.

In FIG. 6, a structure of the DNN extrapolating the excitation signal is depicted. Shapes of the signals given in brackets omitting the batch dimension. T is the length of the input signal.

At first are 4 convolutional layers followed by two recurrent layers with GRUs [40]. Since we want to compare the performance with the BBWE based on LPCnet [33], the GRUs have the same size as the GRUs in LPCnet. Their matrices are of size 256×256 and 256×16 respectively. A GRU layer computes for each time index t in the input sequence the following operation:

rₜ=σ(Wᵢᵣxₜ+bᵢᵣWₕᵣhₜ₋₁+bₕᵣ) (5)

zₜ=σ(W_{iz}xₜ+b_{iz}W_{hz}hₜ₋₁+b_{hz}) (6)

nₜ=tan h(Wᵢₙxₜ+bᵢₙrₜ⊙(Wₕₙhₜ₋₁+bₕₙ)) (7)

hₜ=(1−zₜ)⊙nₜ+zₜ⊙hₜ₋₁ (8)

where hₜ being the hidden state at time t, cₜ is the input at time t, hₜ₋₁ is the hidden state at time t−1, and rₜ; zₜ; nₜ are the reset, update, and new gates, respectively. σ is the sigmoid activation function, ⊙ and is the Hadamard product.

The purpose of the initial CNN layers is to add a feature dimension to the one-dimensional time-domain signal. This feature dimension is needed by the GRU layers, otherwise the matrices in the GRUs would collapse to simple vectors. CNNs add the feature dimension by operating kernels in parallel, usually phrased as channels. Consequently 256 channels are needed so that the CNN layers and GRU layers are compatible.

This would result in high computational complexity, which can be prevented by splitting the channels into 16 groups of each 16 channels. This is the same as having 16 layers of each 16 channels in parallel. The structure of the CNN layers (kernel size, gated activation etc.) may, e.g., be the same as described with respect to the convolutional BBWE above. Since the output of the second GRU layer still has a feature dimension, it is squeezed to a one-dimensional signal with a single convolutional kernel with kernel size 1.

The main contribution of computational complexity comes from the matrices in the first GRU. To reduce the complexity further, these matrices can be made sparse during training [49].

After initial training iterations with dense matrices, blocks with low magnitude are identified and forced to zero. A Boolean matrix stores the indices of those blocks. With proceeding training, more blocks are forced to zero, until a desired sparseness is achieved. Similar to [32] 16×1 blocks are used while also including all diagonal terms. The final percent of elements preserved of the matrices are:

| | |
|---|---|
| Wᵢᵣ, Wₕᵣ | 5% |
| W_{iz}, W_{hz} | 5% |
| Wᵢₙ, Wₕₙ | 20% |

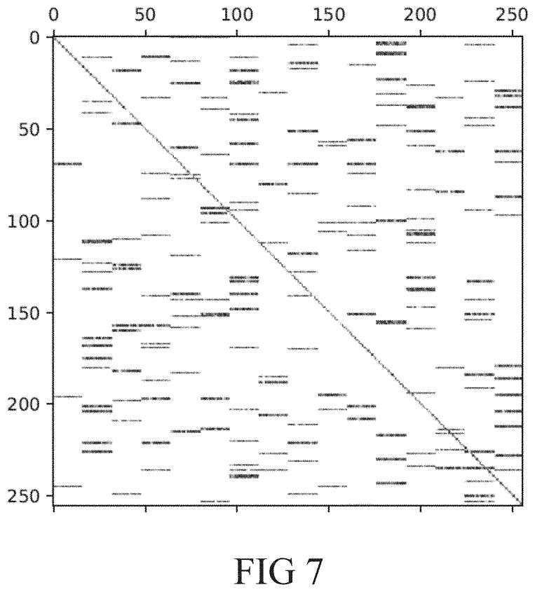

Neglecting the computational overhead of indexing, this sparsification scheme reduces the computational complexity of the GRU by 90%. FIG. 7 shows one of the sparse matrices after training. This system is called LPC-RNN-GAN.

In particular, FIG. 7 illustrates one of the matrices from a GRU after sparsification.

The DNN based on convolutional architectures only has the same structure as the one described in Sc. III-A with three structural differences. First, the size of the CNN kernels is only 17 and second, to compensate the resulting smaller receptive field, this system uses dilated convolutions with a dilation factor of 2 per layer. Third, to save complexity, this system makes use of the above mentioned grouping, by splitting the channel-dimension into 4 groups. Further below, it will be shown that by this the computational complexity can be reduced by a factor of about 3. This system is called LPC-CNN-GAN.

The DNN extrapolating the LPC envelope is also a combination of CNN layers followed by a GRU layer and a final CNN layer. The CNN layers have two-dimensional kernel with kernel size 3 and they operate on the current, one past and one future frame and are the main source of algorithmic delay of the whole system.

In the following, a discriminator according to embodiments is described.

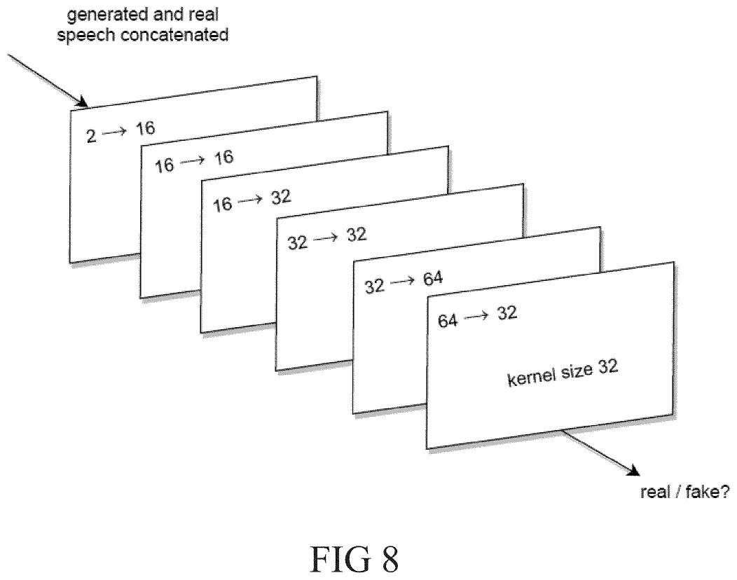

The discriminator acts as a convolutional encoder that extracts a latent representation of the input signal to evaluate the adversarial loss. The CNN-GAN, LPC-CNN-GAN and LPC-RNN-GAN use the same discriminator architecture for the adversarial training, consisting of convolutional layers. A stable adversarial training is achieved by applying spectral normalisation to the convolution kernels of the discriminator layers [50]. This kind of normalisation enforces the Lipschitz condition to the function learned by the discriminator, which was found important for an effective and stable adversarial training procedure. The discriminator operates in conditional setting [51], hence the input signal includes the real/fake WB speech waveform concatenated with the upsampled NB one along the channel dimension. FIG. 8 depicts the discriminator. It consists of 6 convolutional layers, with kernel size of 32 and stride of 2 steps. Biases have been omitted. For activation, we use Leaky ReLU with negative slope of 0:2.

In particular, FIG. 8 illustrates the GAN discriminator network consisting of six convolutional layers with each layer having kernels of 32 samples operating at strides of 2. The numbers in the layers represent the input and output channel dimension of each layer.

Since the conditioning input is time domain NB speech, the discriminator will reject generated speech with a different waveform as the original waveform. The LPCNet based BBWE imposes less constraints on the generated waveform as explained later on. In order to have a GAN that imposes less restrictive constraints to the generated waveform, an second discriminator is evaluated that gets a low dimensional feature representation as input. The features are Mel-frequency cepstral coefficients (MFCCs) [52] calculated on the NB speech. This discriminator, together with the absence of any L^{P}-loss, tends to penalise less generated speech with a waveform different to the original.

Now, training objective considerations are presented.

The adversarial metric used in this work is Hinge loss [53]:

L_{hinge}=max(0,1−D( )) (9)

where D( ) is the raw output of the discriminator. Lim et. al. [53] showed that Hinge loss has less mode collapse and a more stable training behaviour compared to the loss used in the initial GAN paper [36] or the Wasserstein distance [54].

Initial experiments with the proposed systems have shown that hinge loss performs similar as feature matching. As already observed in [30], [25] the adversarial loss can be amended by an L^{P}-norm calculated on samples and on features. Here we use the L¹-norm calculated on time domain samples and as feature loss Lₘₑₗ the L²-norm calculated on logarithmic Mel energies. The total loss training the generator is:

L=(1−λ)L_{hinge}+λ(L¹+Lₘₑₜ) (10)

In the following, an experimental setup is described.

As training material we used several public available speech databases [55], [56], [57] as well as other speech items of different languages. In total, 13 hours of training material were used, all of it resampled to 16 kHz sampling frequency. Silent passages in the training data were removed with a voice-activation-detection [58]. The NB input signal was coded with AMR-NB at 10.2 kbps. The target clean speech signal was pre-emphasised with a first order filter E

E(z)=1−0.68z⁻¹. (11)

The inverse (de-empahsis) filter D

$$D ( z ) = \frac{1}{1 - 0.68 {z}^{- 1}} \qquad ( 12 )$$

was applied to the generated speech. The reason for this is to compensate the spectral tilt of speech which could result in less pronounced high frequencies in the generated speech. The LPC envelope of order 12 is extracted on frames of 128 samples windowed with a Hanning window by calculating the time-domain autocorrelation followed by the Levinson recursion. Thereafter they are converted to an FIR filter, e.g., as explained with respect to LPC-GAN above. The DNNs are trained with batches of 8 items with each items containing 1 second of speech.

The optimisation algorithm for both, the generator and discriminator is Adam [59] with a generator learning rate of 0.0001 and a discriminator learning rate of 0.0004. For a more stable adversarial loss, the coefficients used for computing running averages of the gradient and its square (the beta-parameters) are set to 0.5 and 0.99 respectively. Since RNNs of the LPC-RNN-GAN (see the explanations with respect to LPC-GAN above) usually train slower than CNNs, the learning rate is set to 0.0001 for generator and discriminator. The beta-parameters for training the generator are set to 0.7 and 0.99. The factor A controlling the amount of adversarial loss in Eq. 10 is set to 0.0015. The Sparsification of the GRU layer starts at the 160th batch and the final sparseness is achieved at the 10000th batch. All CNN layers have been trained with batch normalisation for faster training and to prevent the networks falling into mode collapse.

The additional frame-rate network extrapolating LPC coefficients in the LSF domain has 10 CNN layers followed by a single GRU and a final CNN layer. The initial CNN layers are two-dimensional convolutions with kernel size 3×3, 16 channels, tan h-activation functions and residual connections. The GRU has a matrix size of 16×16 and the final convolutional layer with 5 channels, the number of missing LSF coefficients concatenated to the NB LSF coefficients to form the WB LSF coefficients.

Below, the presented systems will be compared to an LCPNet based BBWE in [33]. In contrast to the published system, the DNN used for extrapolating the LPC envelope has here been trained adversarial. For this, the same discriminator architecture has been used, with only adapting the input dimension.

All DNNs were implemented and trained with PyTorch [60].

In the following, evaluation aspects are considered. The provided systems according to embodiments are compared to previously published systems by objective measures and subjectively by a listening test. An estimation of the computational complexity is given and compared to state of the art speech coding technologies. Objective and subjective tests show that the proposed systems deliver substantial better quality than prior techniques. It will be shown that systems according to embodiments reduce the Word Error Rate of a speech recognition systems.

The perceptual quality of the presented BBWEs is evaluated by objective measures previously used to access the quality of speech and subjectively by a listening test. Furthermore, the algorithmic delay and computational complexity are given for each BBWE. Correlation between objective and subjective results are studied to see if they are powerful enough to predict the subjective assessment.

With respect to computational complexity, the computational complexity of the proposed BBWEs is an estimate of weighted million operations per second (WMOPS) per speech-sample. WMOPS is the ITU unit for calculating computational complexity [61] of standardized speech processing tools. Additions (ADD), multiplications (MUL) as well as multiply-add (MAC) operations are each counted as one operation while complex operations like tan h, sigmoid or softmax operations each count as 25 operations. In the following, the number are calculated per speech-sample. This number is multiplied by the sampling frequency to get an estimate of the WMOPS. This should be seen as a rough approximation that doesn't consider advantages of today's parallel processing architectures. The results are summarized in Table I together with the computational complexity of EVS [2], [62], the state-of-the-art standardised speech codec.

In particular, Table I illustrates the computational complexity and algorithmic delay of provided systems according to some embodiments, the LPCNet-BBWE [33] and EVS [2], [62] (EVS is a state-of-the-art standardized speech codec). WMOPS is the ITU standard for calculating computational complexity [61] and calculated at a sampling frequency of 16 kHz.

TABLE I

| | OPS per | | algorithmic |
|---|---|---|---|
| | sample | WMOPs | delay |
| CNN-GAN: | 1387897 | 22206 | 22 ms |
| LPC-RNN-GAN: | 649286 | 10388 | 15 ms |
| LPC-CNN-GAN: | 383353 | 6133 | 22 ms |
| LPCNet: | 130092 | 2081 | 15 ms |
| EVS: | — | 88 | 32 ms |

Regarding computational complexity of CNN-GAN, the complexity of one convolution of one of the kernels of the CNN layer depends only on the kernel size that is denominated here as K. This needs K MAC operations. A CNN layer with Nᵢ input channels and Nₒ output channels has Nᵢ*Nₒ convolutional kernels and, like in fully connected layers, all possible channel combinations are executed. As a result Nᵢ*Nₒ*K MAC operations are executed. As mentioned with respect to the convolutional BBWE above, the output of the CNN layer is split into two parts, one going into a tan h-activation function, the other one going into a softmax activation function followed by an element-wise product. Furthermore the calculation of the residual connection needs Ni ADD operations. Since the number of output channels Nₒ=2*Nᵢ due to the gating mechanism, one convolutional layer executes Nₒ²*K+2*Nₒ*25+Nₒ*2 operations. The initial and final convolutional layer execute Nₒ*K operations each. Tab. I summarises the number of operations for Nₒ=64 channels, kernel size K=32 and 22 layers in total.

Regarding the computational complexity of LPC-RNN-GAN and LPC-CNN-GAN: As mentioned with respect to LPC-GAN above, this system has initial CNN layers that split the one-dimensional signal into 256 channels. These layers are the same CNN layers as above with the difference that the channels are grouped to blocks described with respect to LPC-GAN above. Here a total of 256 channels are grouped to 16 blocks of each 16 channels. This is the same as having 16 CNN layers with 16 channels in parallel.

The operations of one RNN layer for a single speechsample are given in Eq. 5. Let's denominate Mᵢ as the input dimension and Mₕ as the output (or hidden) dimension. Then the calculations of the reset and update gates (first two lines in the equation) each need Mᵢ*Mₕ*2 MAC operations plus Mₕ sigmoid operations. The new gate (third line of the equation) needs Mᵢ*Mₕ*2+Mₕ MAC operations plus Mₕ tangents hyperbolicus operations. Finally the output (last line) needs Mₕ*2 MAC operations. Since the first, large GRU layer uses sparsified matrices (see the explanations with respect to LPC-GAN above), the operations are calculated for the reduced matrix sizes. Overhead due to additional addressing-operations are neglected. For the first GRU all matrices are square with Mᵢ=Mₕ=256, for the second GRU Mᵢ=256 and Mₕ=32.

The final CNN layer just adds up the output dimension and needs 32 ADD operations. The computational complexity of the LPC-CNN-GAN is calculated as above as having 4 such networks with a channel dimension of only 8 in parallel.

At evaluation time, the LPC filter is applied as IIR filter with 12 taps and only needs 12 MAC operations per sample. The conversion of LPC to LSF coefficients and back will be disregarded here, since these conversions are done on a frame base and their contribution to the overall complexity is expected to be small. Table I above summarises the number of operations with the used parameterisation.

With respect to the algorithmic delay, the algorithmic delay is the theoretical delay in ms between the input speech and the processed output speech caused by block-processing of speech samples. CPU or GPU time is not considered. The numbers are summarised in Table I above.

Regarding CNN-GAN, the source of algorithmic delay of the CNN-GAN are the convolutional operations with kernels of size K. Each convolutional layer adds an algorithmic delay of [K/2] samples, since [K/2]−1 tabs of the kernel are calculated on previous samples and do not contribute to the delay. The overall system with 22 convolutional layers and kernels of size 33 has a total delay of 353 samples or 22.0 ms at 16 kHz sampling frequency.

Regarding LPC-RNN-GAN and LPC-CNN-GAN, the source of algorithmic delay of these systems are the initial convolutional layers and the LPC processing. The GRU layers do not introduce any algorithmic delay. The 4 convolutional layers have a kernel size of 16 tabs with a 16 tabs calculated on future samples, hence a delay of 4 ms. Thus the algorithmic delay of the LPC processing, resulting from a windowed autocorrelation function is 15 ms. Since this block processing is independent form the convolutional layer, the total algorithmic delay of the whole system is 15 ms. The LPC-CNN-GAN uses kernels with half the size as the CNN-GAN but with dilation of 2 and thus has the same algorithmic delay as the CNN-GAN.

While a listening test with human listeners is the ultimate base for evaluating the (e.g., objective) perceptual quality, it takes quite some effort to conduct. Objective measures are an easy to use alternative. Here four different measures have been used, Perceptual Objective Listening Quality Analysis, Fr'echet Deep Speech Distance, Word Error Rate and Short-Time Objective Intelligibility measure. All measures except the Word Error Rate are calculated on a multilingual, multiple speaker database of about 1 hour not being part of the training set.

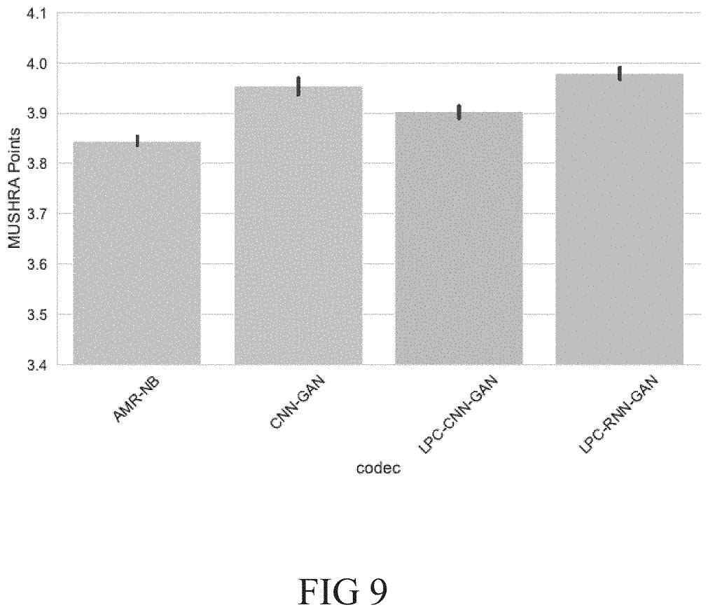

Perceptual Objective Listening Quality Analysis (POLQA) is a standardised method that aims to predict the perceptual quality of coded speech signals on the same Mean Opinion Scale (MOS) used in listening tests [63]. The estimated results are summarized in FIG. 9 and show that the LPC-RNN-GAN achieves the highest ratings, followed by the CNN-GAN.

In particular, FIG. 9 illustrates a Perceptual Objective Listening Quality Analysis (POLQA) of different BBWEs with 95% confidence intervals. Higher values mean better quality.

The evaluation of the quality of speech or images generated by GANs is a difficult task. In the typical use case GANs generate items from noise and metrics based on an L^{P}-norm cannot be used since there is no reference to compare with.

The Frechet Deep Speech Distance (FDSD) may e.g., be considered. A common objective measure to assess the quality of images created by GANs is the Frechet inception distance (FID) [64]. This metric is calculated on the output of a different DNN trained to classify images or speech. Opposed to generative modelling, image and speech classification (recognition) is already quite elaborated and the entropy of the output of a DNN classifying the generated data might give an estimate of the quality. Items that are classified strongly as one class over all other classes indicate a high quality and the conditional probability of generated items should have a low entropy. Furthermore, GANs should generate a large variety of items (not suffer from mode collapse) and therefore it is advantageous for the integral of the marginal probability distribution of the classification output to have a high entropy. The inception distance (ID) in [65] formulates this mathematically. Heusel et. al. [65] have improved this by also using the distribution of classification results of real data based on the Frechet distance:

FID=∥μᵣ−μ_{g}∥2+Tr(Σᵣ−Σ_{g}−2(ΣᵣΣ_{g})^{1/2}). (13)

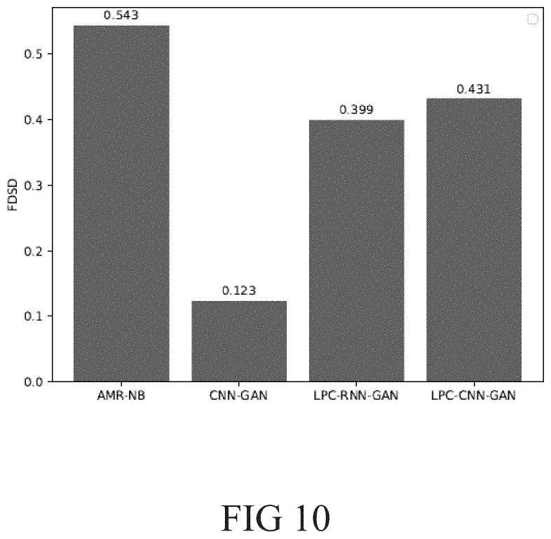

Here μᵣ; μᵣ; Σᵣ; Σ_{g} are the mean and covariance of the output of a classification network of real and generated data respectively. The Frechet Deep Speech Distance (FDSD) proposed by Binkowski et. al. [66] uses the DeepSpeech 2 speech recognition network [67] to calculate the Frechet distance that is also used in this work. FIG. 10 gives the FDSD scores of the different BBWEs.

FIG. 10 illustrates the Frechet Deep Speech Distance (FDSD) of different BBWEs. Lower values mean better quality.

Regarding the Word Error Rate, besides improving the perceptual quality, a BBWE can also improve the intelligibility of speech [5], [6] and furthermore, the performance of automatic speech recognition (ASR) systems. State of the art ASR systems are based on DNNs trained on speech with a fixed sampling frequency, mostly 16 kHz. As a result the performance of such systems drops significantly when the speech is coded with a NB codec. The impact of coding speech with AMR-NB on the word error rate (WER) of a state of the art ASR system and how BBWE can mitigate this impact is evaluated. The ASR system used here is Mozilla's open implementation of the RNN based DeepSpeech system [68] with Connectionist temporal classification (CTC) loss [69] trained on the common voice multilingual speech corpus [70]. The evaluation is done on the evaluation set from this database. The WER metric is evaluated at the word level of the transcribed speech and computes:

$$WER = \frac{S + D + I}{S + D + C} \qquad ( 14 )$$

where S is the number of substitutions, D is the number of deletions, I is the number of insertions and C is the number of correct words of a transcription.

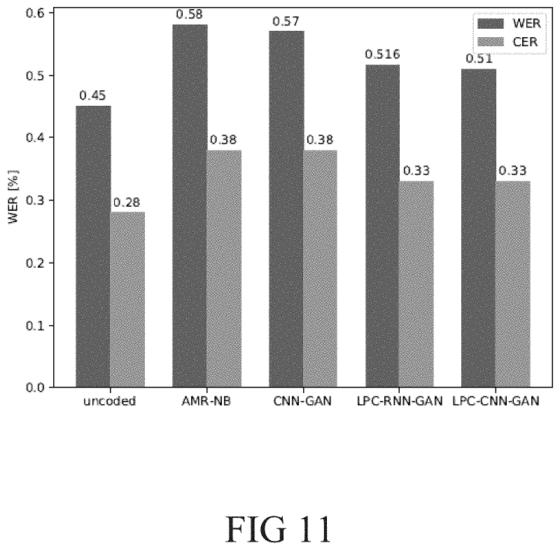

FIG. 11 depicts a word error rate (WER) and character error rate (CER) of different BBWEs. Lower values mean better performance. In particular, FIG. 11 depicts the ASR performance of AMR-NB and the different BBWEs together with the character error rate (CER) which is calculated similar to WER but on a character level instead of a word level.

Table II provides an example of one of the worst performing items. It is interesting to see, that although uncoded items perform better in average, there are no outliers with a performance worse than 0:6 with AMR-NB coded items from the database. BBWE processed items improve the average WER but also produce outliers with a WER of 8:0 and more.

TABLE II illustrates examples of worst case ASR performing items.

TABLE II

| | WER | original | result |
|---|---|---|---|
| uncoded | 1.67 | “i'm not drivel- | “i am at the level” |
| | | ling” | |
| AMR-NB | 0.6 | “every purchase | “are purchases a vote” |
| | | is a vote” | |
| CNN-GAN | 9.0 | “undefined” | “the thing honour and |
| | | | he bent on the corner” |
| LPC-RNN-GAN | 9.0 | “undefined” | “the thing honour and |
| | | | even on the corner of” |
| LPC-CNN-GAN | 8.0 | “undefined” | “everything over and |
| | | | he banished round the |
| | | | corner” |

Regarding the Short-Time Objective Intelligibility measure (STOI), the Short-Time Objective Intelligibility measure (STOI) is defined as an estimate of the linear correlation coefficient between the temporal energy envelopes of clean and BBWE-processed speech sub-bands. These sub-bands are calculated on a time-frequency-representation, obtained from segmenting speech signals into 50% overlapping, Hanning-windowed frames with a length of 256 samples, where each frame is zero-padded up to 512 samples and Fourier transformed. 15 one-third octave bands are calculated by averaging DFT-bins.

Originally this measure is calculated on speech sampled with 10 kHz sampling frequency. Since we are assessing the quality of WB speech, this measure is extended to 16 kHz.

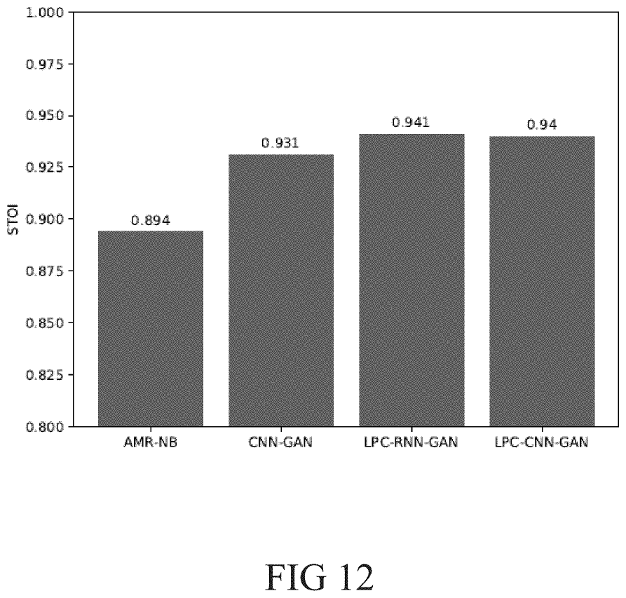

FIG. 12 shows the results for the presented systems.

In particular, FIG. 12 illustrates a Short-Time Objective Intelligibility measure (STOI) for the presented systems. Smaller values mean lower quality.

According to this measure the LPC-RNN-GAN performs best, followed by the LPC-CNN-GAN.

In the following, the subjective perceptual quality is considered.

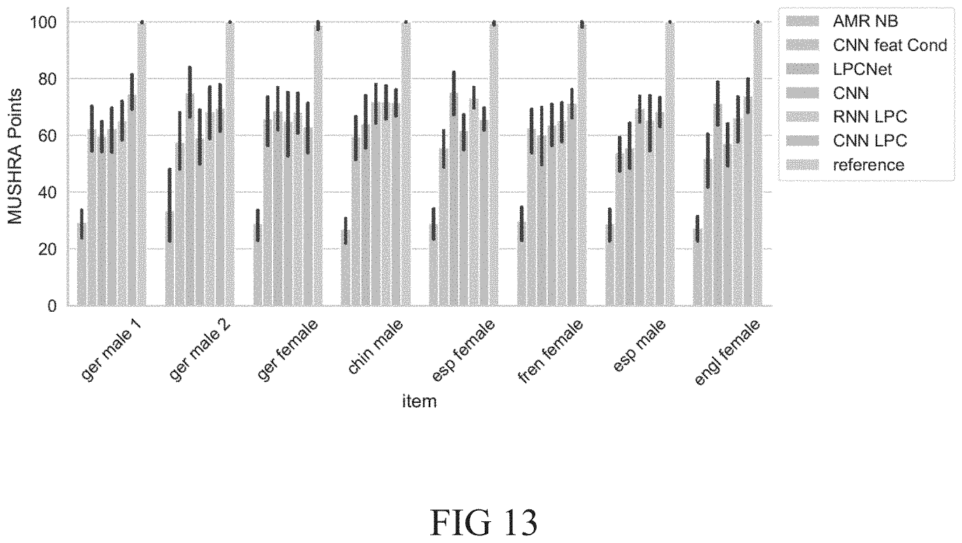

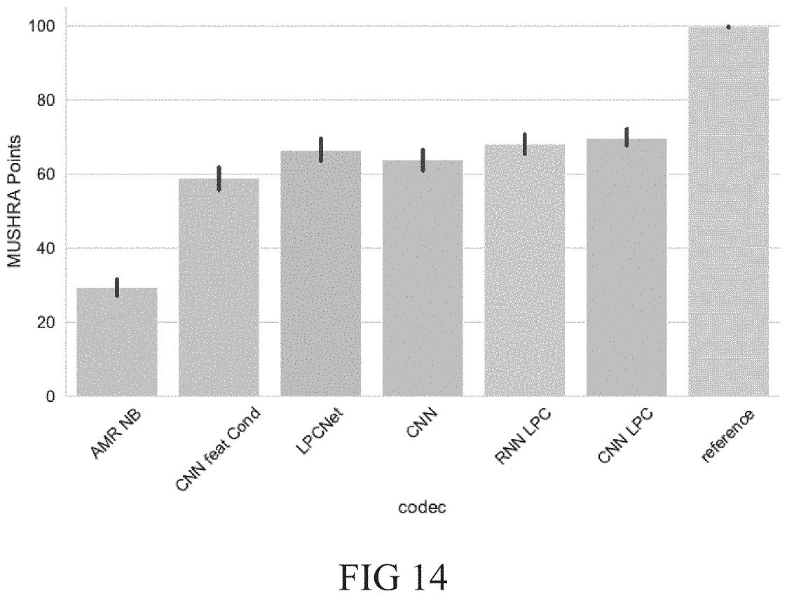

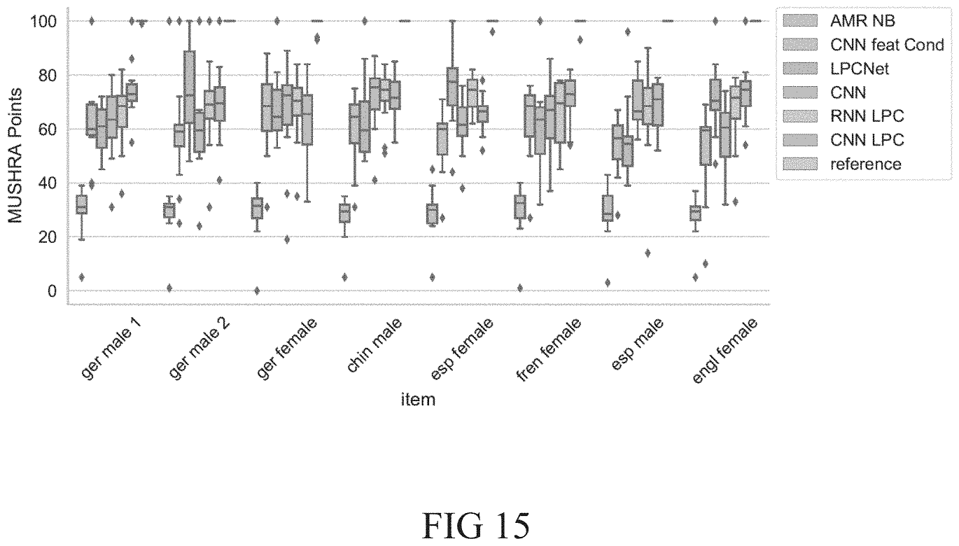

To ultimately judge the perceptual quality of the proposed systems, a MUSHRA listening test [71] was conducted. According to the MUSHRA methodology, the test items contain the reference marked as such, a hidden reference and the AMR-NB coded signal serving as anchor. 12 experienced listeners participated in the test. The speech items used in the test are about 10 seconds long and neither part of the training nor the test set. The items contain Chinese, English, French, German and Spanish speech from native speakers. The results are presented in FIG. 13 per item and in FIG. 14 averaged over all items as box plots with mean values and 95% confidence intervals. FIG. 15 shows the results as bar plot.

In particular, FIG. 13 illustrates results from listening test evaluating different BBWEs as boxplot with 95% confidence intervals per item.

FIG. 14 illustrates results from listening test evaluating different BBWEs as bar plot with 95% confidence intervals averaged over all items.

FIG. 15 illustrates results from listening test evaluating different BBWEs as warm plot showing the ratings from each user.

The system marked as CNN-feat-cond is the CNN-GAN trained with a discriminator whose conditional input is based on features as explained above regarding the discriminator. The L¹-loss is also removed from the training objective.

The results show that all presented systems significantly improve the quality of AMR-NB speech for all items. Except for the CNN-feat-cond, none of the presented systems is significantly better than the others. The tendentially best system is the LPC-CNN-GAN which is also significantly better than the CNN-feat-cond system.

Inspecting the results from single items it strikes that the quality is fairly dependent on the item. The LPC-CNN-GAN is not always the best performing system. For Spanish female, German female and male 2 items, the LPCNet based system performs best. For the Chinese male items the LPC-RNN-GAN performs best, for the Spanish male item the CNN-GAN performs best. The CNN-GAN often has the fewest noisy artefacts but frequently fails to reconstruct fricatives well.

The variance in quality is especially high for the LPCNet based system. This system sometimes delivers very high quality with occasional severe artefacts like clicks and unstable pitch. The GAN based systems, on the other, hand do not suffer from such severe artefacts but from broadband crackling noise. The LPCNet based system, and also sometimes the feature conditioning based system, change the characteristic of the voice since both systems impose less constraints on the generated waveform. In a MUSHRA test this can result in lower scoring as in different test methods like Absolute Category Rating (ACR) tests where the reference is not given.

In order to see how well the objective measures reflect the subjective assessments, the correlation with MOS values from the listening test is studied. For fair comparison all measures are normalised to zero mean and standard deviation. Since FDSD, WER and CER are giving lower values for better quality estimates, their values are negated first.

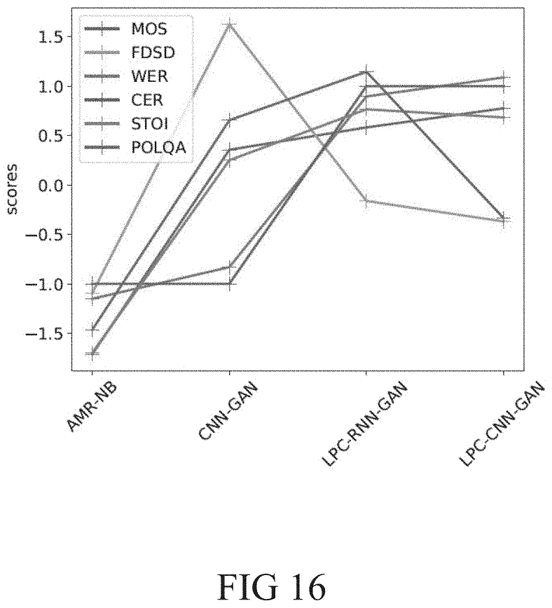

FIG. 16 shows the normalised values and Tab. III the correlation values.

In particular, FIG. 16 illustrates normalised objective and subjective measures. TABLE III illustrates a correlation of subjective MOS values with objectives measures.

TABLE III

| | |
|---|---|
| STOI: | 0.99 |
| FDSD: | 0.518 |
| WER: | 0.76 |
| CER: | 0.68 |
| POLQA: | 0.79 |

It can be seen that STOI has the highest correlation with the MOS value, followed by POLQA, WER and CER.WER, however, is the only measure that has the same order as the listening test results. The difference between WER and FDSD values is strange, since both measures are based on the output of similar networks (DeepSpeech and DeepSpeech 2).

Two fundamental different approaches to do BBWE have been compared, namely GAN models and an autoregressive model. Both approaches rely on generative models that are able to model complex data distributions, like the distribution of time domain speech and both approaches do not suffer from smoothing problems.

Both approaches have a moderate computational complexity compared to state-of-the-art models like WaveNet® [35].

The LPCNet based BBWE is the model with the lowest computational complexity. The main reason for the lower complexity is, that this model imposes less constrains on the generated waveform. The waveform generated by LPCNet can be very different to the original waveform, while the GAN based BBWEs are preserving the original waveform due to conditioning and a mix of adversarial loss and L¹—loss. Unfortunately changing the conditioning to feature conditioning and removing the L¹—loss didn't improve the quality of the generated speech.

The LPC-RNN-GAN and the LPC-CNN-GAN differ in the DNN used for excitation signal extrapolation. The first is based on a mixture of CNNs and RNNs, the latter uses CNNs only.

Both DNNs have about the same computational complexity. Although there is no significant difference in performance, the LPC-CNN-GAN performs tendentially better. In addition, the training time of CNNs is shorter and they are less delicate to hyperparameter tunings. The LPC-RNN-GAN successfully applies sparsification in the context of GAN training for the first time.

Correlating the results from the listening test with the objective measures gives ambiguous results. Although the authors in [66] showed that the FDSD measure is performing well in estimating the quality of adversarial generated speech, it fails here to access the small differences between the presented systems. The measure correlating best with the subjective results are the STOI and WER measures.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] International Telecommunication Union, “Pulse code modulation (pcm) of voice frequencies,” ITU-T Recommendation G.711, November 1988.
[2] S. Bruhn, H. Pobloth, M. Schnell, B. Grill, J. Gibbs, L. Miao, K. Jārvinen, L. Laaksonen, N. Harada, N. Naka, S. Ragot, S. Proust, T. Sanda, I. Varga, C. Greer, M. Jelinek, M. Xie, and P. Usai, “Standardization of the new 3GPP EVS codec,” in 2015 IEEE International Conference on Acoustics, Speech and Signal Processing, ICASSP 2015, South Brisbane, Queensland, Australia, Apr. 19-24, 2015, 2015, pp. 5703-5707. [Online]. Available: https://doi.org/10.1109/ICASSP.2015.7179064
[3] S. Disch, A. Niedermeier, C. R. Helmrich, C. Neukam, K. Schmidt, R. Geiger, J. Lecomte, F. Ghido, F. Nagel, and B. Edler, “Intelligent gap filling in perceptual transform coding of audio,” in Audio Engineering Society Convention 141, Los Angeles, September 2016. [Online]. Available: http://www.aes.org/e-lib/browse.cfm?elib=18465
[4] 3GPP, “TS 26.090, Mandatory Speech Codec speech processing functions; Adaptive Multi-Rate (AMR) speech codec; Transcoding functions,” 1999.
[5] P. Bauer, R. Fischer, M. Bellanova, H. Puder, and T. Fingscheidt, “On improving telephone speech intelligibility for hearing impaired persons,” in Proceedings of the 10. ITG Conference on Speech Communication, Braunschweig, Germany, Sep. 26-28, 2012, 2012, pp. 1-4. [Online]. Available: http://ieeexplore.ieee.org/document/6309632/[6]
[6] P. Bauer, J. Jones, and T. Fingscheidt, “Impact of hearing impairment on fricative intelligibility for artificially bandwidth-extended telephone speech in noise,” in IEEE International Conference on Acoustics, Speech and Signal Processing, ICASSP 2013, Vancouver, BC, Canada, May 26-31, 2013, 2013, pp. 7039-7043. [Online]. Available: https://doi.org/10.1109/ICASSP.2013.6639027
[7] J. Abel, M. Kaniewska, C. Guillaume, W. Tirry, H. Pulakka, V. Myllylä, J. Sjoberg, P. Alku, I. Katsir, D. Malah, I. Cohen, M. A. T. Turan, E. Erzin, T. Schlien, P. Vary, A. H. Nour-Eldin, P. Kabal, and T. Fingscheidt, “A subjective listening test of six different artificial bandwidth extension approaches in english, chinese, german, and korean,” in 2016 IEEE International Conference on Acoustics, Speech and Signal Processing, ICASSP 2016, Shanghai, China, Mar. 20-25, 2016, 2016, pp. 5915-5919. [Online]. Available: https://doi.org/10.1109/ICASSP.2016.7472812
[8] K. Schmidt and B. Edler, “Blind bandwidth extension based on convolutional and recurrent deep neural networks,” in 2018 IEEE International Conference on Acoustics, Speech and Signal Processing (ICASSP), April 2018, pp. 5444-5448.
[9] K. Schmidt, “Neubildung von unterdrückten Sprachfrequenzen durch ein nichtlinear verzerrendes Glied,” Dissertation, Techn. Hochsch. Berlin, 1933.
[10] M. Schroeder, “Recent progress in speech coding at bell telephone laboratories,” in Proceedings of the third international congress on acoustics, Stuttgart, 1959.
[11] Y. Lecun, L. Bottou, Y. Bengio, and P. Haffner, “Gradient-based learning applied to document recognition,” Proceedings of the IEEE, vol. 86, no. 11, pp. 2278-2324, November 1998.
[12] C. Ledig, L. Theis, F. Huszar, J. Caballero, A. P. Aitken, A. Tejani, J. Totz, Z. Wang, and W. Shi, “Photo-realistic single image super-resolution using a generative adversarial network,” CoRR, vol. abs/1609.04802, 2016. [Online]. Available: http://arxiv.org/abs/1609. 04802
[13] X. Li, V. Chebiyyam, and K. Kirchhoff, “Speech audio super-resolution for speech recognition,” in Interspeech 2019, 20th Annual Conference of the International Speech Communication Association, Graz, Austria, Sep. 15-19, 2019, 09 2019.
[14] P. Jax and P. Vary, “Wideband extension of telephone speech using a hidden markov model,” in 2000 IEEE Workshop on Speech Coding. Proceedings., 2000, pp. 133-135.
[15] K. Schmidt and B. Edler, “Deep neural network based guided speech bandwidth extension,” in Audio Engineering Society Convention 147, October 2019. [Online]. Available: http://www.aes.org/e-lib/browse.cfm? elib=20627
[16] H. Carl and U. Heute, “Bandwidth enhancement of narrow-band speech signals,” in Signal Processing VII: Theories and Applications: Proceedings of EUSIPCO-94 Seventh European Signal Processing Conference, September 1994, pp. 1178-1181.
[17] H. Pulakka and P. Alku, “Bandwidth extension of telephone speech using a neural network and a filter bank implementation for highband mel spectrum,” IEEE Trans. Audio, Speech & Language Processing, vol. 19, no. 7, pp. 2170-2183, 2011. [Online]. Available: https://doi.org/10.1109/TASL.2011.2118206
[18] K. Li and C. Lee, “A deep neural network approach to speech bandwidth expansion,” in 2015 IEEE International Conference on Acoustics, Speech and Signal Processing, ICASSP 2015, South Brisbane, Queensland, Australia, Apr. 19-24, 2015, 2015, pp. 4395-4399. [Online]. Available: https://doi.org/10.1109/ICASSP.2015.7178801
[19] P. Bauer, J. Abel, and T. Fingscheidt, “Hmm-based artificial bandwidth extension supported by neural networks,” in 14th International Workshop on Acoustic Signal Enhancement, IWAENC 2014, Juan-les-Pins, France, Sep. 8-11, 2014, 2014, pp. 1-5. [Online]. Available: https://doi.org/10.1109/IWAENC.2014.6953304
[20] J. Sautter, F. Faubel, M. Buck, and G. Schmidt, “Artificial bandwidth extension using a conditional generative adversarial network with discriminative training,” in ICASSP 2019-2019 IEEE International Conference on Acoustics, Speech and Signal Processing (ICASSP), May 2019, pp. 7005-7009.
[21] J. Abel, M. Strake, and T. Fingscheidt, “A simple cepstral domain dnn approach to artificial speech bandwidth extension,” in 2018 IEEE International Conference on Acoustics, Speech and Signal Processing (ICASSP), April 2018, pp. 5469-5473.
[22] J. Abel and T. Fingscheidt, “Artificial speech bandwidth extension using deep neural networks for wideband spectral envelope estimation,” IEEE/ACM Transactions on Audio, Speech, and Language Processing, vol. 26, no. 1, pp. 71-83, 2018.
[23] Z. Ling, Y. Ai, Y. Gu, and L. Dai, “Waveform modeling and generation using hierarchical recurrent neural networks for speech bandwidth extension,” IEEE/ACM Transactions on Audio, Speech, and Language Processing, vol. 26, no. 5, pp. 883-894, May 2018.
[24] A. Gupta, B. Shillingford, Y. M. Assael, and T. C. Walters, “Speech bandwidth extension with wavenet,” ArXiv, vol. abs/1907.04927, 2019.
[25] S. Kim and V. Sathe, “Bandwidth extension on raw audio via generative adversarial networks,” 2019.
[26] Y. Dong, Y. Li, X. Li, S. Xu, D. Wang, Z. Zhang, and S. Xiong, “A time-frequency network with channel attention and non-local modules for artificial bandwidth extension,” in ICASSP 2020-2020 IEEE International Conference on Acoustics, Speech and Signal Processing (ICASSP), 2020, pp. 6954-6958.
[27] J. Makhoul and M. Berouti, “High-frequency regeneration in speech coding systems,” in ICASSP '79. IEEE International Conference on Acoustics, Speech, and Signal Processing, April 1979, pp. 428-431.
[28] N. Kalchbrenner, E. Elsen, K. Simonyan, S. Noury, N. Casagrande, E. Lockhart, F. Stimberg, A. van den Oord, S. Dieleman, and K. Kavukcuoglu, “Efficient neural audio synthesis,” CoRR, vol. abs/1802.08435, 2018. [Online]. Available: http://arxiv.org/abs/1802. 08435
[29] S. Li, S. Villette, P. Ramadas, and D. J. Sinder, “Speech bandwidth extension using generative adversarial networks,” in 2018 IEEE International Conference on Acoustics, Speech and Signal Processing (ICASSP), April 2018, pp. 5029-5033.
[30] S. E. Eskimez, K. Koishida, and Z. Duan, “Adversarial training for speech super-resolution,” IEEE Journal of Selected Topics in Signal Processing, vol. 13, no. 2, pp. 347-358, 2019.
[31] X. Hao, C. Xu, N. Hou, L. Xie, E. S. Chng, and H. Li, “Time-domain neural network approach for speech bandwidth extension,” in ICASSP 2020-2020 IEEE International Conference on Acoustics, Speech and Signal Processing (ICASSP), 2020, pp. 866-870.
[32] J. Valin and J. Skoglund, “Lpcnet: Improving neural speech synthesis through linear prediction,” in ICASSP 2019-2019 IEEE International Conference on Acoustics, Speech and Signal Processing (ICASSP), May 2019, pp. 5891-5895.
[33] K. Schmidt and B. Edler, “Blind bandwidth extension of speech based on Ipcnet,” in 2020 28th European Signal Processing Conference (EUSIPCO).
[34] L. Rabiner and R. Schafer, Digital Processing of Speech Signals. Englewood Cliffs: Prentice Hall, 1978.
[35] A. van den Oord, S. Dieleman, H. Zen, K. Simonyan, O. Vinyals, A. Graves, N. Kalchbrenner, A. W. Senior, and K. Kavukcuoglu, “Wavenet: A generative model for raw audio,” in The 9th ISCA Speech Synthesis Workshop, Sunnyvale, Calif., USA, 13-15 September 2016, 2016, p. 125.
[36] I. J. Goodfellow, J. Pouget-Abadie, M. Mirza, B. Xu, D. Warde-Farley, S. Ozair, A. Courville, and Y. Bengio, “Generative adversarial networks,” 2014.
[37] Y. Gu and Z. Ling, “Waveform modeling using stacked dilated convolutional neural networks for speech bandwidth extension,” in Interspeech 2017, 18th Annual Conference of the International Speech Communication Association, Stockholm, Sweden, August 20-24, 2017, 2017, pp. 1123-1127. [Online]. Available: http: //www.isca-speech.org/archive/Interspeech 2017/abstracts/0336.html
[38] S. Hochreiter and J. Schmidhuber, “Long short-term memory,” Neural Computation, vol. 9, no. 8, pp. 1735-1780, 1997. [Online]. Available: https://doi.org/10.1162/neco.1997.9.8.1735
[39] Y. Gu, Z. Ling, and L. Dai, “Speech bandwidth extension using bottleneck features and deep recurrent neural networks,” in Interspeech 2016, 17th Annual Conference of the International Speech Communication Association, San Francisco, Calif., USA, Sep. 8-12, 2016, 2016, pp. 297-301. [Online]. Available: https://doi.org/10.21437/Interspeech.2016-678
[40] J. Chung, Q. Gülçehre, K. Cho, and Y. Bengio, “Empirical evaluation of gated recurrent neural networks on sequence modeling,” NIPS Deep Learning workshop, Montreal, Canada, 2014. [Online]. Available: http://arxiv.org/abs/1412.3555
[41] A. van den Oord, N. Kalchbrenner, O. Vinyals, L. Espeholt, A. Graves, and K. Kavukcuoglu, “Conditional image generation with pixelcnn decoders,” CoRR, vol. abs/1606.05328, 2016. [Online]. Available: http://arxiv.org/abs/1606.05328
[42] W. B. Kleijn, F. S. C. Lim, A. Luebs, J. Skoglund, F. Stimberg, Q. Wang, and T. C. Walters, “Wavenet based low rate speech coding,” in 2018 IEEE International Conference on Acoustics, Speech and Signal Processing (ICASSP), April 2018, pp. 676-680.
[43] Z. Jin, A. Finkelstein, G. J. Mysore, and J. Lu, “Fftnet: A real-time speaker-dependent neural vocoder,” in 2018 IEEE International Conference on Acoustics, Speech and Signal Processing (ICASSP), April 2018, pp. 2251-2255.
[44] J.-M. Valin and J. Skoglund, “A real-time wideband neural vocoder at 1.6 kb/s using Ipcnet,” ArXiv, vol. abs/1903.12087, 2019.
[45] A. Mustafa, A. Biswas, C. Bergler, J. Schottenhamml, and A. Maier, “Analysis by Adversarial Synthesis—A Novel Approach for Speech Vocoding,” in Proc. Interspeech, 2019, pp. 191-195. [Online]. Available: http://dx.doi.org/10.21437/Interspeech.2019-1195
[46] T. Salimans and D. P. Kingma, “Weight normalization: A simple reparameterization to accelerate training of deep neural networks,” in Advances in NeurIPS, 2016, pp. 901-909.
[47] K. He, X. Zhang, S. Ren, and J. Sun, “Deep residual learning for image recognition,” in Proceedings of the IEEE conference on computer vision and pattern recognition, 2016, pp. 770-778.
[48] Yao Tianren, Xiang Juanjuan, and Lu Wei, “The computation of line spectral frequency using the second chebyshev polynomials,” in 6th International Conference on Signal Processing, 2002., vol. 1, August 2002, pp. 190-192 vol. 1.
[49] N. Kalchbrenner, E. Elsen, K. Simonyan, S. Noury, N. Casagrande, E. Lockhart, F. Stimberg, A. van den Oord, S. Dieleman, and K. Kavukcuoglu, “Efficient neural audio synthesis,” 2018.
[50] T. Miyato, T. Kataoka, M. Koyama, and Y. Yoshida, “Spectral normalization for generative adversarial networks,” 2018.
[51] M. Mirza and S. Osindero, “Conditional generative adversarial nets,” ArXiv, vol. abs/1411.1784, 2014.
[52] A. Salman, E. Muhammad, and K. Khurshid, “Speaker verification using boosted cepstral features with gaussian distributions,” in 2007 IEEE International Multitopic Conference, 2007, pp. 1-5. [53] J. H. Lim and J. C. Ye, “Geometric gan,” 2017.
[54] M. Arjovsky, S. Chintala, and L. Bottou, “Wasserstein gan,” 2017.
[55] C. Veaux, J. Yamagishi, and K. Macdonald, “Cstr vctk corpus: English multi-speaker corpus for cstr voice cloning toolkit,” 2017.
[56] V. Panayotov, G. Chen, D. Povey, and S. Khudanpur, “Librispeech: An ASR corpus based on public domain audio books,” in 2015 IEEE International Conference on Acoustics, Speech and Signal Processing, ICASSP 2015, South Brisbane, Queensland, Australia, Apr. 19-24, 2015, 2015, pp. 5206-5210. [Online]. Available: https://doi.org/10.1109/ICASSP.2015.7178964
[57] M. Sołoducha, A. Raake, F. Kettler, and P. Voigt, “Lombard speech database for german language,” in Proc. DAGA 2016 Aachen, 03 2016.
[58] “Webrtc vad v2.0.10,” https://webrtc.org.
[59] D. P. Kingma and J. Ba, “Adam: A method for stochastic optimization,” CoRR, vol. abs/1412.6980, 2014.
[60] A. Paszke, S. Gross, F. Massa, A. Lerer, J. Bradbury, G. Chanan, T. Killeen, Z. Lin, N. Gimelshein, L. Antiga, A. Desmaison, A. Kopf, E. Yang, Z. DeVito, M. Raison, A. Tejani, S. Chilamkurthy, B. Steiner, L. Fang, J. Bai, and S. Chintala, “Pytorch: An imperative style, high-performance deep learning library,” in Advances in Neural Information Processing Systems 32, H. Wallach, H. Larochelle, A. Beygelzimer, F. d'Alché-Buc, E. Fox, and R. Garnett, Eds. Curran Associates, Inc., 2019, pp. 8024-8035. [Online]. Available: http://papers.neurips.cc/paper/9015-pytorch-an-imperative-style-high-performance-deep-learning-library.pdf
[61] ITU-T Study Group 12, Software tools for speech and audio coding standardization, Geneva, 2005.
[62] G. T. 26.445, “EVS codec; detailed algorithmic description; technical specification, release 12,” September 2014.
[63] ITU-T Study Group 12, P.863: Perceptual objective listening quality prediction, Geneva, 2018.
[64] M. Heusel, H. Ramsauer, T. Unterthiner, B. Nessler, G. Klambauer, and S. Hochreiter, “Gans trained by a two time-scale update rule converge to a nash equilibrium,” CoRR, vol. abs/1706.08500, 2017. [Online]. Available: http://arxiv.org/abs/1706.08500
[65] T. Salimans, I. Goodfellow, W. Zaremba, V. Cheung, A. Radford, X. Chen, and X. Chen, “Improved techniques for training gans,” in Advances in Neural Information Processing Systems, D. Lee, M. Sugiyama, U. Luxburg, I. Guyon, and R. Garnett, Eds., vol. 29. Curran Associates, Inc., 2016, pp. 2234-2242. [Online]. Available: https://proceedings.neurips.cc/paper/2016/file/8a3363abe792db2d8761d6403605aeb7-Paper.pdf
[66] M. Binkowski, J. Donahue, S. Dieleman, A. Clark, E. Elsen, N. Casagrande, L. C. Cobo, and K. Simonyan, “High fidelity speech synthesis with adversarial networks,” CoRR, vol. abs/1909.11646, 2019. [Online]. Available: http://arxiv.org/abs/1909.11646
[67] D. Amodei, R. Anubhai, E. Battenberg, C. Case, J. Casper, B. Catanzaro, J. Chen, M. Chrzanowski, A. Coates, G. Diamos, E. Elsen, J. H. Engel, L. Fan, C. Fougner, T. Han, A. Y. Hannun, B. Jun, P. LeGresley, L. Lin, S. Narang, A. Y. Ng, S. Ozair, R. Prenger, J. Raiman, S. Satheesh, D. Seetapun, S. Sengupta, Y. Wang, Z. Wang, C. Wang, B. Xiao, D. Yogatama, J. Zhan, and Z. Zhu, “Deep speech 2: End-to-end speech recognition in english and mandarin,” CoRR, vol. abs/1512.02595, 2015. [Online]. Available: http://arxiv.org/abs/1512.02595
[68] A. Y. Hannun, C. Case, J. Casper, B. Catanzaro, G. Diamos, E. Elsen, R. Prenger, S. Satheesh, S. Sengupta, A. Coates, and A. Y. Ng, “Deep speech: Scaling up end-to-end speech recognition,” CoRR, vol. abs/1412.5567, 2014. [Online]. Available: http://arxiv.org/abs/1412.5567
[69] A. Graves, S. Fernandez, and F. Gomez, “Connectionist temporal classification: Labelling unsegmented sequence data with recurrent neural networks,” in In Proceedings of the International Conference on Machine Learning, ICML 2006, 2006, pp. 369-376.
[70] R. Ardila, M. Branson, K. Davis, M. Henretty, M. Kohler, J. Meyer, R. Morais, L. Saunders, F. M. Tyers, and G. Weber, “Common voice: A massively-multilingual speech corpus,” CoRR, vol. abs/1912.06670, 2019. [Online]. Available: http://arxiv.org/abs/1912.06670
[71] ITU-R, Recommendation BS.1534-1 Method for subjective assessment of intermediate sound quality (MUSHRA), Geneva, 2003.

1. An apparatus for processing a speech input signal by conducting bandwidth extension of the speech input signal to acquire a speech output signal, wherein the apparatus comprises:
a signal envelope extrapolator comprising a first neural network, wherein the first neural network is configured to receive as input values of the first neural network a plurality of samples of a signal envelope of the narrowband speech input signal, and configured to determine as output values of the first neural network a plurality of extrapolated signal envelope samples;
an excitation signal extrapolator configured to receive a plurality of samples of an excitation signal of the speech input signal, and configured to determine a plurality of extrapolated excitation signal samples; and
a combiner configured to generate the speech output signal such that the speech output signal is bandwidth extended with respect to the speech input signal depending on the plurality of extrapolated signal envelope samples and depending on the plurality of extrapolated excitation signal samples.

2. An apparatus according to claim 1,
wherein the input values of the first neural network are a first plurality of line spectral frequencies of the speech input signal, and wherein the first neural network is configured to determine as the output values of the first neural network a second plurality of line spectral frequencies of the speech output signal; wherein each of one or more of the second plurality of line spectral frequencies is associated with a frequency being greater than any frequency being associated with any of the first plurality of line spectral frequencies.

3. An apparatus according to claim 2,
wherein, when the first neural network is trained, the signal envelope extrapolator is configured to transform a plurality of linear predictive coding coefficients, being derived from an original speech signal, into Finite impulse response filter coefficients by calculating an impulse response and by truncating the impulse response.

4. An apparatus according to claim 3,
wherein, when the first neural network is trained, the signal envelope extrapolator is configured to feed back an error or a gradient of the error between the speech output signal and the original speech signal.

5. An apparatus according to claim 1,
wherein the first neural network is to be trained using a first discriminator neural network; wherein, when the first neural network is trained, the first neural network and the first discriminator neural network are arranged to operate as a generative adversarial network;
wherein, during training of the first neural network, the first discriminator neural network is arranged to receive, as input values of the first discriminator neural network, the output values of the first neural network or is arranged to receive, as the input values of the first discriminator network, derived values being derived from the output values of the first neural network;
wherein, on receiving the input values of the first discriminator neural network, the first discriminator neural network is configured to determine, as output of the first discriminator neural network, a first quality indication for the input values of the first discriminator neural network; and wherein the first neural network is configured to be trained depending on the first quality indication.

6. An apparatus according to claim 5,
wherein, on receiving the input values of the first discriminator neural network, the first discriminator neural network is configured to determine the quality indication such that the quality indication indicates a probability for that the input values of the first discriminator neural network relate to a recorded speech signal instead of an artificially generated speech signal, or indicates an estimation whether the output values of the first discriminator neural network relate to a recorded signal or to an artificially generated signal.

7. An apparatus according to claim 5,
wherein the first neural network or the second neural network has been trained using a loss function depending on the quality indication determined by the first discriminator neural network.

8. An apparatus according to claim 7,
wherein the loss function depends on a Hinge loss or depends on a Wasserstein distance or depends on an entropy-based loss.

9. An apparatus according to claim 8,
wherein the loss function depends on a Hinge loss L_{hinge} being defined as:
L_{hinge}=max(0,1−D( ))
wherein D( ) indicates the output of the first discriminator neural network.

10. An apparatus according to claim 7,
wherein the loss function depends on an additional L^{P}-loss.

11. An apparatus according to claim 9,
wherein the loss function is defined according to:
L=(1−λ)L_{hinge}+λ(L¹+Lₘₑₜ).

12. An apparatus according to claim 4,
wherein the first discriminator neural network has been trained using recorded speech.

13. An apparatus according to claim 1,
wherein the excitation signal extrapolator comprises a second neural network, wherein the second neural network is configured to receive as input values of the second neural network the plurality of samples of the excitation signal of the speech input signal, and/or is the speech input signal and/or, is a shaped version of the speech input signal, and configured to determine as output values of the second neural network the plurality of extrapolated excitation signal samples.

14. An apparatus according to claim 13,
wherein the input values of the second neural network are a first plurality of time-domain signal samples of the excitation signal of the speech input signal, and/or is the speech input signal and/or, is a shaped version of the speech input signal, wherein the second neural network is configured to determine the output values of the second neural network such that the plurality of extrapolated excitation signal samples are a second plurality of time-domain signal samples of an extended time-domain excitation signal being bandwidth-extended with respect to the excitation signal of the speech input signal.

15. An apparatus according to claim 13,
wherein the second neural network is to be trained using a second discriminator neural network, wherein, during training of the second neural network, the second neural network and the second discriminator neural network are arranged to operate as a second generative adversarial network;
wherein, during training of the second neural network, the second discriminator neural network is arranged to receive, as input values of the second discriminator neural network,
the output values of the second neural network or is arranged to receive, as the input values of the second discriminator network, derived values being derived from the output values of the second neural network; and/or
an output of the combiner;
wherein, on receiving the input values of the second discriminator neural network, the second discriminator neural network is configured to determine, as output of the second discriminator neural network, a second quality indication for the input values of the second discriminator neural network; and wherein the second neural network is configured to be trained depending on the second quality indication.

16. An apparatus according to claim 1,
wherein the apparatus comprises a signal analyser configured to generate the plurality of samples of the signal envelope of the speech input signal and the plurality of samples of the excitation signal of the speech input signal from the speech input signal.

17. An apparatus according to claim 1,
wherein the first neural network comprises one or more convolutional neural networks.

18. An apparatus according claim 1,
wherein the first neural network comprises one or more deep neural networks.

19. A method for processing a speech input signal by conducting bandwidth extension of the speech input signal to acquire a speech output signal, wherein the method comprises:
receiving, as input values of a first neural network, a plurality of samples of a signal envelope of the speech input signal, and determining as output values of the first neural network a plurality of extrapolated signal envelope samples;
receiving a plurality of samples of an excitation signal of the speech input signal, and determining a plurality of extrapolated excitation signal samples; and
generating the speech output signal such that the speech output signal is bandwidth extended with respect to the speech input signal depending on the plurality of extrapolated signal envelope samples and depending on the plurality of extrapolated excitation signal samples.

20. A method for training a neural network,
wherein the neural network receives as input values of the neural network are a first plurality of line spectral frequencies of a speech input signal;
wherein the neural network determines as output values of the first neural network a second plurality of line spectral frequencies of the speech output signal;
wherein each of one or more of the second plurality of line spectral frequencies is associated with a frequency being greater than any frequency being associated with any of the first plurality of line spectral frequencies;
wherein the second plurality of line spectral frequencies of the speech output signal is transformed from a line spectral frequency domain to a linear predictive coding domain to acquire a second plurality of the linear predictive coding coefficients of the speech output signal;
wherein a finite impulse response filter is employed to transform the second plurality of the linear predictive coding coefficients of the speech output signal from the linear predictive coding domain to a finite impulse response filter domain to acquire a plurality of finite-impulse-filter-transformed linear predictive coding coefficients;
wherein the method comprises training the first neural network depending on the plurality of finite-impulse-filter-transformed linear predictive coding coefficients.

21. A method according to claim 20,
wherein, when the first neural network is trained, the plurality of finite-impulse-filter-transformed linear predictive coding coefficients or values derived from the plurality of finite-impulse-filter-transformed linear predictive coding coefficients are fed back into the neural network.

22. A method according to claim 20,
wherein, when the first neural network is trained, a plurality of samples of the speech output signal are generated depending on the plurality of finite-impulse-filter-transformed linear predictive coding coefficients and depending on a plurality of extrapolated excitation signal samples, and the plurality of the speech output signal or values derived from the plurality of samples of the speech output signal are fed back into the neural network.

23. A method for training a first and/or a second neural network,
wherein the first neural network receives as input values of the first neural network a plurality of samples of a signal envelope of the speech input signal, and determines as output values of the first neural network a plurality of extrapolated signal envelope samples; and/or wherein the second neural network receives as input values of the second neural network the plurality of samples of the excitation signal of the speech input signal, and determines as output values of the second neural network the plurality of extrapolated excitation signal samples;
wherein the first and/or the second neural network is trained using a discriminator neural network; wherein, when the first and/o the second neural network is trained, the first and/or the second neural network and the discriminator neural network operate as a generative adversarial network;
wherein, during training of the first and/or the second neural network, the discriminator neural network receives, as input values of the discriminator neural network, the output values of the first and/or the second neural network or receives, as the input values of the discriminator network, derived values being derived from the output values of the first and/or the second neural network;
wherein, on receiving the input values of the discriminator neural network, the discriminator neural network determines, as output of the discriminator neural network, a quality indication for the input values of the discriminator neural network; and wherein the first neural network and/or the second is trained depending on the quality indication.

24. A method according to claim 23,
wherein the discriminator neural network is a first discriminator neural network;
wherein the first neural network is trained using the first discriminator neural network; wherein the first neural network is trained depending on the quality indication being a first quality indication;
wherein the second neural network is trained using a second discriminator neural network, wherein, during training of the second neural network, the second neural network and the second discriminator neural network operate as a second generative adversarial network;
wherein, during training of the second neural network, the second discriminator neural network receives, as input values of the second discriminator neural network, the output values of the second neural network or receives, as the input values of the second discriminator network, derived values being derived from the output values of the second neural network;
wherein, on receiving the input values of the second discriminator neural network, the second discriminator neural network determines, as output of the second discriminator neural network, a second quality indication for the input values of the second discriminator neural network; and wherein the second neural network is configured to be trained depending on the second quality indication.

25. A non-transitory digital storage medium having a computer program stored thereon to perform the method for processing a speech input signal by conducting bandwidth extension of the speech input signal to acquire a speech output signal, wherein the method comprises:
receiving, as input values of a first neural network, a plurality of samples of a signal envelope of the speech input signal, and determining as output values of the first neural network a plurality of extrapolated signal envelope samples;
receiving a plurality of samples of an excitation signal of the speech input signal, and determining a plurality of extrapolated excitation signal samples; and
generating the speech output signal such that the speech output signal is bandwidth extended with respect to the speech input signal depending on the plurality of extrapolated signal envelope samples and depending on the plurality of extrapolated excitation signal samples,
when said computer program is run by a computer.

26. A non-transitory digital storage medium having a computer program stored thereon to perform the method for training a neural network, wherein the neural network receives as input values of the neural network are a first plurality of line spectral frequencies of a speech input signal;
wherein the neural network determines as output values of the first neural network a second plurality of line spectral frequencies of the speech output signal;
wherein each of one or more of the second plurality of line spectral frequencies is associated with a frequency being greater than any frequency being associated with any of the first plurality of line spectral frequencies;
wherein the second plurality of line spectral frequencies of the speech output signal is transformed from a line spectral frequency domain to a linear predictive coding domain to acquire a second plurality of the linear predictive coding coefficients of the speech output signal;
wherein a finite impulse response filter is employed to transform the second plurality of the linear predictive coding coefficients of the speech output signal from the linear predictive coding domain to a finite impulse response filter domain to acquire a plurality of finite-impulse-filter-transformed linear predictive coding coefficients;
wherein the method comprises training the first neural network depending on the plurality of finite-impulse-filter-transformed linear predictive coding coefficients,
when said computer program is run by a computer.

27. A non-transitory digital storage medium having a computer program stored thereon to perform the method for training a first and/or a second neural network,
wherein the first neural network receives as input values of the first neural network a plurality of samples of a signal envelope of the speech input signal, and determines as output values of the first neural network a plurality of extrapolated signal envelope samples; and/or wherein the second neural network receives as input values of the second neural network the plurality of samples of the excitation signal of the speech input signal, and determines as output values of the second neural network the plurality of extrapolated excitation signal samples;
wherein the first and/or the second neural network is trained using a discriminator neural network; wherein, when the first and/o the second neural network is trained, the first and/or the second neural network and the discriminator neural network operate as a generative adversarial network;
wherein, during training of the first and/or the second neural network, the discriminator neural network receives, as input values of the discriminator neural network, the output values of the first and/or the second neural network or receives, as the input values of the discriminator network, derived values being derived from the output values of the first and/or the second neural network;
wherein, on receiving the input values of the discriminator neural network, the discriminator neural network determines, as output of the discriminator neural network, a quality indication for the input values of the discriminator neural network;
and wherein the first neural network and/or the second is trained depending on the quality indication,
when said computer program is run by a computer.

28. An apparatus according to claim 1,
wherein the speech input signal is a narrowband speech input signal, and/or wherein the speech output signal is a wideband speech output signal.
